(19) United States
(12) Patent Application Publication
(10) Pub. No.: US 2024/0208501 A1
(43) Pub. Date: Jun. 27, 2024

(54) VEHICLE DATA GENERATION SERVER AND VEHICLE CONTROL DEVICE

(71) Applicants: DENSO CORPORATION, Kariya-city (JP); TOYOTA JIDOSHA KABUSHIKI KAISHA, Toyota-shi (JP)

(72) Inventor: GENKI KITAHARA, Tokyo (JP)

(21) Appl. No.: 18/597,718

(22) Filed: Mar. 6, 2024

Related U.S. Application Data
(63) Continuation of application No. PCT/JP2022/032096, filed on Aug. 25, 2022.

(30) Foreign Application Priority Data
Sep. 9, 2021 (JP) 2021-146928

(51) Int. Cl. B60W 30/14; B60W 30/16; B60W 30/18; B60W 50/14; G06V 20/58

(52) U.S. Cl. CPC B60W 30/146; B60W 30/16; B60W 30/18154; B60W 50/14; G06V 20/584; B60W 2050/146; B60W 2420/403; B60W 2552/53; B60W 2554/802; B60W 2555/60; B60W 2556/65

(57) ABSTRACT

A vehicle data generation server acquires, from each of multiple vehicles, a data set indicating (i) a travel lane of the corresponding vehicle, (ii) a combination of activated colors of the traffic signal observed by the corresponding vehicle, and (iii) a behavior of the corresponding vehicle with respect to the combination of activated colors of the traffic signal, as a traffic signal response report. The vehicle data generation server generate, as traffic signal response policy data for each traffic signal, passable pattern data indicating, for each lane, a combination of activated colors under which passing is possible, based on the traffic signal response reports acquired from the multiple vehicles. The passable pattern data indicates, for the combination of activated colors, one or more passable lane numbers, but does not include data indicating a shape of each activated light element of the traffic signal.

### CROSS REFERENCE TO RELATED APPLICATIONS

The present application is a continuation application of International Patent Application No. PCT/JP2022/032096 filed on Aug. 25, 2022, which designated the U.S. and claims the benefit of priority from Japanese Patent Application No. 2021-146928 filed on Sep. 9, 2021. The entire disclosures of all of the above applications are incorporated herein by reference.

### TECHNICAL FIELD

The present disclosure relates to a vehicle data generation server and a vehicle control device, each of which generates data for assisting vehicle control with respect to a traffic signal with arrow light.

### BACKGROUND

In a related art, a vehicle-mounted device recognizes a lighting state of traffic signal by combining location information of each light element constituting the traffic signal.

### SUMMARY

The present disclosure provides a vehicle data generation server that generates vehicle control data with respect to a traffic signal. The vehicle data generation server is configured to: acquire, from each of multiple vehicles, a data set as a traffic signal response report, the data set indicating information on (i) a travel lane of the corresponding vehicle, (ii) a combination of activated colors of the traffic signal observed by the corresponding vehicle, and (iii) a behavior of the corresponding vehicle with respect to the combination of activated colors of the traffic signal; generate, as traffic signal response policy data for each traffic signal, passable pattern data indicating, for each lane, a combination of activated colors under which passing is possible, based on the traffic signal response reports acquired from the multiple vehicles; and transmit the traffic signal response policy data that is generated to an external device. The passable pattern data is a data set indicating, for the combination of activated colors, one or more passable lane numbers. The passable pattern data does not include data indicating a shape of each activated light element included in the traffic signal.

### BRIEF DESCRIPTION OF DRAWINGS

Objects, features and advantages of the present disclosure will become apparent from the following detailed description made with reference to the accompanying drawings.

FIG. 1 is a diagram showing an overall configuration of a map cooperation system.

FIG. 2 is a block diagram showing a configuration of a vehicle control system.

FIG. 3 is a block diagram showing a configuration of a front camera.

FIG. 4 is a functional block diagram of a drive assist ECU.

FIG. 5 is a diagram showing an example of an entry prohibition image.

FIG. 6 is a diagram showing an example of an entry possible image.

FIG. 7 is a flowchart showing a traffic signal response report process.

FIG. 8 is a diagram showing an example of items included in a traffic signal response report.

FIG. 9 is a block diagram showing a configuration of a map generation server.

FIG. 10 is a flowchart showing an example of a procedure for generating traffic signal response policy data.

FIG. 11 is a view showing an example of road structure.

FIG. 12 is a view showing an example of a traffic signal for a road shown in FIG. 11.

FIG. 13 is a diagram showing an example of passable pattern data.

FIG. 14 is a diagram showing another example of passable pattern data.

FIG. 15 is a diagram showing an example of stop pattern data.

FIG. 16 is a diagram showing another example of stop pattern data.

FIG. 17 is a diagram showing an example of passable pattern data.

FIG. 18 is a diagram showing an example of lighting pattern of a traffic signal with multiple green arrow lights.

FIG. 19 is a diagram showing passable pattern data corresponding to the lighting pattern of traffic signal shown in FIG. 18.

FIG. 20 is a diagram showing an example of a lighting pattern of traffic signal with multiple green arrow lights.

FIG. 21 is a diagram showing passable pattern data corresponding to the lighting pattern of traffic signal shown in FIG. 20.

FIG. 22 is a flowchart corresponding to a traffic signal passing assistance process.

FIG. 23 is a diagram showing a relationship between a distance from a traffic signal and an image recognition result with respect to a green arrow light.

FIG. 24 is a diagram showing a setting example of an area number indicating lighting elements of a horizontal traffic signal.

FIG. 25 is a diagram showing a setting example of an area number indicating lighting elements of a vertical traffic signal.

FIG. 26 is a diagram showing another example of items included in the traffic signal response report.

FIG. 27 is a diagram showing a configuration example of passable pattern data that is generated using location information of lighting elements.

FIG. 28 is a diagram showing passable pattern data when passable patterns for respective lanes are indicated by relative locations of green activated elements with respect to red activated elements.

### DETAILED DESCRIPTION

Before describing embodiments of the present disclosure, a related art disclosed in JP 2021-2275 A (corresponding to US 2020/0401824 A1) will be described. The related art of JP 2021-2275 discloses a configuration in which a vehicle-mounted device recognizes a lighting state of traffic signal by combining location information of each light element constituting the traffic signal, lighting pattern information indicating a lighting color and a lighting shape thereof, and a detection result of the lighting state of traffic signal, which are detected by a vehicle-mounted camera. The lighting shape may be a circle, an arrow, a numeric number, or the like. For the light element having the arrow shape, information related to the direction of arrow may also be included in the lighting state. A green arrow light, which is an arrow-shaped light element that turns on in green, is often in on state in parallel with a red circular light, which is a circular light element that turns on in red, as a sign that limitedly or exceptionally permits passing of vehicles in certain directions indicated by the arrow. In the present disclosure, a traffic signal with a green arrow light is also referred to as a traffic signal with arrow light.

When a red light in a forward traffic signal with arrow light is in activated state, that is, turned-on state and an associated green arrow light is in activated state, the vehicle can move without stop depending on a traveling lane of the vehicle. When the light element of traffic signal included in the image captured by the vehicle-mounted camera is small, although the color of light element can be determined, it is difficult to accurately determine the shape of activated light element. That is, it is difficult to determine whether the shape of activated light element is an arrow or the direction of arrow by image recognition. The difficulty level may increase as a distance between the vehicle and the traffic signal increases. Under a bad environment, such as rainfall or fog, the recognition accuracy of the shape of light element turned on in green may be deteriorated as compared with that under nice weather.

With consideration of such circumstance, there is a demand for generating data, based on which a vehicle can determine whether to stop before an intersection even though the shape of activated light element is unknown. This kind of data can be generated as data for assisting vehicle control with respect to a traffic signal with arrow light.

When the vehicle can use the lighting pattern information as disclosed in JP 2021-2275 A, it is possible to determine whether to make a stop in response to the traffic signal with green arrow light based on an arrangement pattern of activated light elements specified by image recognition. However, the lighting pattern information disclosed in JP 2021-2275 A includes detailed information, such as each activated light element of traffic signal has what shape and what color. Such lighting pattern data may have a large data size. In addition, data management may become complicated. From the viewpoint of reducing communication processing load, the data used in the vehicle is required to be simple and have a small data size. In JP 2021-2275 A, there is no disclosure about how to generate detailed lighting pattern information.

The present disclosure has been made in view of the above issue, and an object of the present disclosure is to provide a vehicle data generation server and a vehicle control device, each of which is capable of generating data for determining whether to make a stop before an intersection based on a lighting state of traffic signal.

According to an aspect of the present disclosure, a vehicle data generation server generates vehicle control data with respect to a traffic signal. the vehicle data generation server includes: a report acquiring unit acquiring, from each of multiple vehicles, a data set as a traffic signal response report, the data set indicating information on (i) a travel lane of the corresponding vehicle, (ii) a combination of activated colors of the traffic signal observed by the corresponding vehicle, and (iii) a behavior of the corresponding vehicle with respect to the combination of activated colors of the traffic signal; a traffic signal response policy generation unit generating, as traffic signal response policy data for each traffic signal, passable pattern data indicating, for each lane, a combination of activated colors under which passing is possible, based on the traffic signal response reports acquired by the report acquiring unit; and a transmission processing unit transmitting the traffic signal response policy data generated by the traffic signal response policy generation unit to an external device. The passable pattern data is a data set indicating, for the combination of activated colors, one or more passable lane numbers. The passable pattern data does not include data indicating a shape of each activated light element included in the traffic signal.

The vehicle data generation server generates and transmits, as the traffic signal response policy data, a data set indicating a combination of a passable/stop lighting color for each lane. The host vehicle can determine whether to pass through the intersection at current time by comparing the lane number of host vehicle lane and the recognition result of the lighting color of the traffic signal with the traffic signal response policy data. At this time, since it is not necessary to recognize the shape of activated light element such as the direction of the arrow, it is possible to determine whether or not the vehicle can pass the traffic signal without stop from a relatively long distance. In addition, even when a camera or an image recognition device has a relatively low resolution, it is possible to determine passing propriety indicating whether passing the traffic signal is possible under a condition that combination of colors can be specified. Note that the traffic signal response policy data indicates passing propriety for each lane by a combination of colors, and does not necessarily need to include shape information of activated light element and arrangement location information of activated light element within the traffic signal housing. Thus, size of the data related to the traffic signal can be suppressed compared with the lighting pattern information disclosed in JP 2021-2275 A. With the above-described vehicle data generation server, it is possible to generate data used to determine whether to make a stop before an intersection based on the lighting state of traffic signal.

According to another aspect of the present disclosure, a vehicle control device is configured to perform a preceding vehicle following control by controlling a host vehicle to follow a preceding vehicle with a predetermined distance being maintained from the preceding vehicle. The vehicle control device includes: a host vehicle lane recognition unit recognizing, based on an input from a vehicle-mounted device, a lane number of a host vehicle lane when counted from a left or right edge of a road, the host vehicle lane being a lane in which a host vehicle is traveling; a lighting state acquiring unit acquiring data indicating a lighting state of a traffic signal corresponding to the host vehicle lane; a response policy data receiving unit receiving, from a predetermined external device, traffic signal response policy data indicating a combination of passable lighting colors set for each lane or a combination of lighting colors under which passing is prohibited for each lane, as data related to the traffic signal located along the road which the host vehicle is scheduled to travel; a passing propriety determination unit determining whether the lighting state of the traffic signal corresponds to a passable lighting state in which passing is defined to be possible, based on (i) the traffic signal response policy data received by the response policy data receiving unit, (ii) the lane number of the host vehicle lane, and (iii) the lighting state of the traffic signal acquired by the lighting state acquiring unit; and a response unit performing a vehicle control in response to a determination result of the passing propriety determination unit. The response unit continues the preceding vehicle following control when the passing propriety determination unit determines that passing is possible and the host vehicle is scheduled to travel straight at an intersection where the traffic signal is located. The response unit interrupts the preceding vehicle following control when the passing propriety determination unit determines that passing is prohibited at the intersection where the traffic signal is located.

The vehicle control device performs vehicle control using the traffic signal response policy data generated by the vehicle data generation server. According to the vehicle control device, even when the shape of activated light element of the traffic signal cannot be recognized, it is possible to determine whether the host vehicle can pass through the intersection based on the combination of colors of the activated light elements.

Hereinafter, an embodiment of a vehicle control system 1 according to the present disclosure will be described with reference to the accompanying drawings. In the following description, an area where left-hand traffic is legislated will be described as an example. The present disclosure can be implemented with appropriate modifications conforming to the local laws and practices in which the vehicle control system 1 is to be used. For example, in an area where right-hand traffic is legislated, the left and right in the following description of left turn/right turn at an intersection can be reversed for implementation purpose.

Hereinafter, it is assumed that a green light included in the traffic signal 9 indicates a lighting state in which passing is permitted, and yellow and red lights indicate a lighting state in which stop is required. The term of “green” as the lighting color in the present disclosure may be interpreted as blue in Japan. The term of “yellow” as the lighting color in the present disclosure may be interpreted as “amber” in some countries or areas, such as England.

A traffic signal 9 may include a traffic signal 9A with arrow lights. The arrow light includes a lighting device that displays an arrow in a certain color. In the present disclosure, as an example, the traffic signal 9 to which a green arrow light for displaying an arrow in green is added is mainly described as the traffic signal 9A with arrow light. The green arrow light is a lighting device that limitedly permits passing in a direction indicated by the green arrow. The traffic signal 9 provided with the green arrow light is also referred to as traffic signal with arrow light in Japan. The green arrow light may also be referred to as a blue arrow light. The green arrow light corresponds to a lighting device that displays a green arrow. Note that, as the arrow light, there are a yellow arrow light that displays a yellow arrow, a red arrow light that displays a red arrow, and the like in addition to the green arrow light. The present disclosure can also be appropriately applied to the traffic signal 9 including a yellow arrow light and a red arrow light.

### Overall Configuration

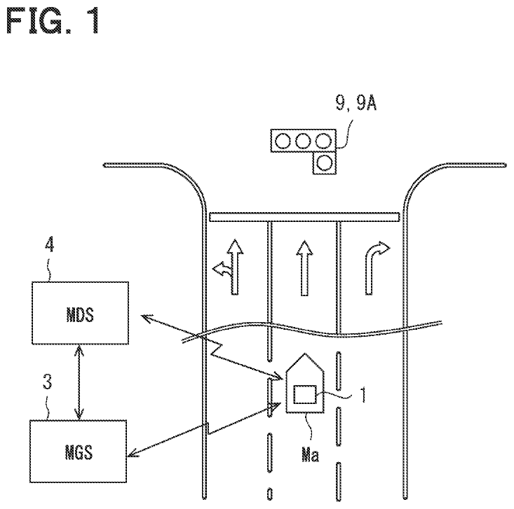

FIG. 1 is a diagram illustrating an example of a schematic configuration of a map cooperation system Sys including a vehicle control system 1 according to the present disclosure. As illustrated in FIG. 1, the map cooperation system Sys includes a vehicle control system 1 constructed in a vehicle Ma, a map generation server 3, and a map distribution server 4. Although only one vehicle Ma equipped with the vehicle control system 1 is illustrated in FIG. 1, there may be multiple vehicles Ma equipped with respective vehicle control systems 1. That is, there may be multiple vehicles constituting the map cooperation system Sys. MGS illustrated in FIG. 1 is an abbreviation for Map Generation Server. MDS illustrated in FIG. 1 is an abbreviation for Map Distribution/Delivery Server.

The vehicle control system 1 may be mounted on various types of vehicles Ma capable of traveling on a road. The vehicle Ma may be a two-wheeled vehicle, a three-wheeled vehicle, or the like in addition to a four-wheeled vehicle. Bicycles with motors may also be included in two-wheeled vehicles. The vehicle Ma may be a vehicle owned by an individual, or may be a vehicle provided for a car sharing service or a vehicle rental service (known as rental car). The vehicle Ma may be a service car. The service car includes a taxi, a fixed route bus, a shared bus, and the like. The taxi or the bus may be a robot taxi or unmanned taxi in which a driver is not on board.

The vehicle control system 1 transmits, to the map generation server 3, a lighting state of traffic signal observed during traveling and position information of various planimetric features. The map generation server 3 generates map data used in the vehicle control system 1 based on information provided from multiple vehicles, and provides partial or entire map data to the map distribution server 4. The vehicle control system 1 downloads necessary map data from the map distribution server 4 by performing wireless communication with the map distribution server 4, and uses the map data for driving assist, automated driving, and navigation.

### Configuration of Map Data

The following will describe an example of map data used by the vehicle control system 1, in other words, the map data distributed by the map distribution server 4. The map data distributed by the map distribution server 4 is basically the same as the map data generated by the map generation server 3. The map distribution server 4 may generate distribution data corresponding to the application based on the map data provided by the map generation server 3, and distribute the map data to the vehicle corresponding to the application. The map data generated by the map generation server 3 and the map data actually distributed to the vehicle may not be completely the same. In the present embodiment, as an example, a server that generates map data (traffic signal data) is separately provided from a server that distributes map data to the vehicles. Note that the present disclosure is not limited this example. The map generation server 3 and the map distribution server 4 may be integrated as one map server.

The map data includes road structure data and planimetric feature data. The road structure data is network data indicating a connection relationship of roads, and may include node data and link data. The node data is data related to nodes, such as intersections, points where a quantity of lanes increases or decreases, and points where roads branch or merge. The link data is data related to road links each of which is a road section connecting nodes. The link data includes data, such as lane information, curvature, and gradient of the road link. A road link may also be referred to as a road segment. The data related to road structure may be described in units of lanes. The road structure data may include lane network data indicating a connection relationship at a lane level. A link ID, which is a unique identifier, is assigned to each road link or each lane link.

The planimetric feature data can be classified into road edge data, road marking data, and three-dimensional object data. The road edge data indicates the position of road edge. The road marking data indicates the installation position and the type of road marking. The road marking refers to a paint drawn on a road surface for regulation or instruction related to road traffic. For example, the road marking may be referred to as pavement paint. For example, the road marking includes a lane marking line indicating a boundary of lane, a pedestrian crossing, a stop line, a flow guide zone, a safety zone, a regulation arrow, and the like. Lines, symbols, and characters located on the road surface correspond to road markings. The road marking may include not only paint but also a line, a symbol, and a character formed by a different color from the road surface color, a road stud, a stone, or the like.

The three-dimensional object data indicates the position and type of a predetermined three-dimensional object installed along the road. The three-dimensional object installed along the road may include a traffic sign, a commercial signboard, a pole, a guardrail, a curbstone, a utility pole, a traffic light, or the like. For example, the traffic sign refers to a signboard to which at least one of a symbol, a character string, and a pattern functioning as a regulation sign, a guide sign, a warning sign, an instruction sign, or the like is provided. In the map data, data related to traffic signs and traffic signals 9 is recorded as three-dimensional object data.

The traffic signal data included in the map data includes center coordinates of the housing, an arrangement type, size information, green arrow light information, and passable pattern data. The arrangement type indicates whether the light elements of three colors are arranged vertically or horizontally. The arrangement type corresponds to information indicating whether the traffic signal is a vertical traffic signal or a horizontal traffic signal. The arrangement type also corresponds to information indicating an installation posture of traffic signal. The size information indicates horizontal and vertical lengths of traffic signal. The arrow light information indicates the presence or absence, a quantity, and a direction of the green arrow light. For example, the green arrow light information indicates whether a green arrow light is included in the traffic signal. The green arrow light information may also indicate the quantity of green arrow lights provided to the traffic signal. In the traffic signal 9 to which the green arrow light is provided, the green arrow light information also includes the direction of green arrow light. The passable pattern data indicates a combination of passable activated colors for each lane. The passable pattern data will be described later.

Data related to various planimetric features is associated with network data. For example, a planimetric feature provided on a specific lane, such as a traffic light, or a planimetric feature for a specific lane is associated with belonging (corresponding) link data or node data. Partial or entire of the planimetric features and predetermined road markings such as a temporary stop lines arranged on the road surface are used as landmarks to be described later. That is, the map data includes data indicating the installation position and the type of landmark.

The map data is managed (generated/updated/distributed) by being divided into multiple patches. Each patch corresponds to map data of a specific area, which is different from another area. For example, the map data is stored in units of map tiles obtained by dividing a map recording area into rectangular shapes. The map tile corresponds to a subordinate concept of the patch. A tile ID, which is a unique identifier, is assigned to each map tile. The map data for each patch or each map tile is a part of the entire map recording area, in other words, local map data. The map tile corresponds to partial map data. The map distribution server 4 distributes partial map data corresponding to the position of vehicle control system 1 in response to a request from the vehicle control system 1.

The recording range of each patch may have a shape other than rectangular. The recording range of patch may be a hexagon, a circle, or the like. Each patch may be set to partially overlap with an adjacent patch. That is, each patch may be set to overlap with another patch in the vicinity of the boundary. The division mode of the map data may be defined by the data size. The map recording area may be divided and managed in a range defined by the data size. In this case, each patch is set so that the amount of data is less than a predetermined value. According to this configuration, the data size of one data transmission can be set to be equal to or less than a certain value.

For example, the above-described map data is updated at any time by integrating probe data uploaded from multiple vehicles. The map data in the map cooperation system Sys of the present embodiment is a probe data map (hereinafter referred to as a PD map) generated and updated by integrating probe data observed in multiple vehicles. As another aspect, the map data in the map cooperation system Sys may be a high-precision map (hereinafter referred to as an HD map) generated based on a result of fixed-point surveying, a result of high-precision GPS surveying, or data measured by a dedicated probe car equipped with LiDAR or the like. LiDAR is an abbreviation for Light Detection and Ranging or Laser Imaging Detection and Ranging. The LiDAR may include a time-of-flight (ToF) camera that generates a distance image. The map data in the map cooperation system Sys may be navigation map data, which is map data for navigation use, on condition that the map data includes planimetric feature data such as traffic signals 9 and landmarks.

### Configuration of Vehicle Control System 1

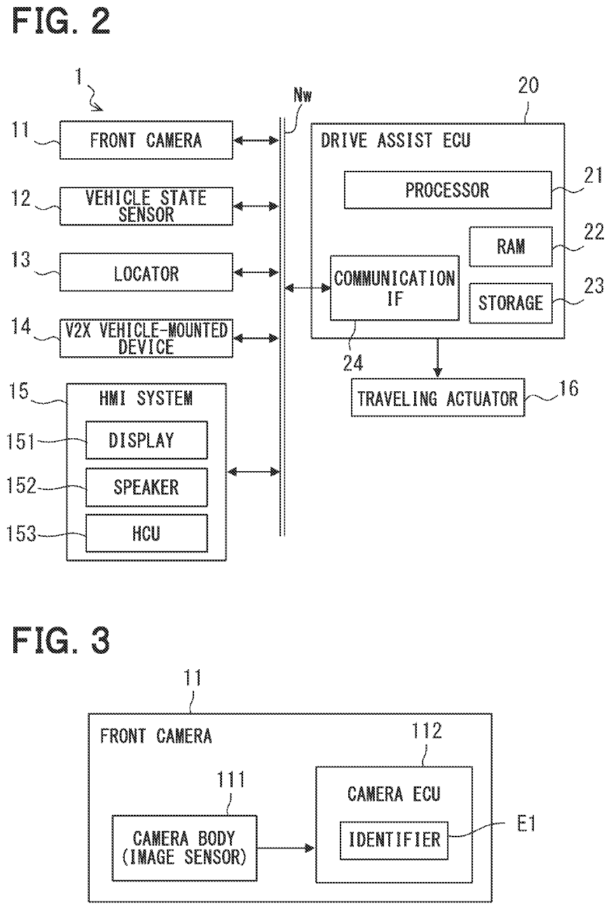

As illustrated in FIG. 2, the vehicle control system 1 includes a front camera 11, a vehicle state sensor 12, a locator 13, a V2X vehicle-mounted device 14, an HMI system 15, a traveling actuator 16, and a drive assist ECU 20. Note that ECU is an abbreviation for Electronic Control Unit and means an electronic control device. HMI is an abbreviation for Human Machine Interface. V2X is an abbreviation of Vehicle to X (Everything) and refers to a communication technology that connects a vehicle to various objects. Note that “V” in “V2X” may indicate an automobile as a host vehicle, and “X” in “V2X” may indicate various entities other than the host vehicle, such as a pedestrian, another vehicle, road equipment, a network, and a server.

The host vehicle in the present disclosure refers to the vehicle Ma on which the vehicle control system 1 is mounted. In the present disclosure, an occupant sitting on the driver's seat of the vehicle Ma (that is, a driver seat occupant) is also referred to as a user. The concept of the driver seat occupant also includes an operator who is an entity having authority to remotely operate the vehicle Ma. In the following description, front and rear, left and right, and up and down directions are defined with reference to the host vehicle. Specifically, the front-rear direction corresponds to the longitudinal direction of the host vehicle. The left-right direction corresponds to the width direction of the host vehicle. The up-down direction corresponds to the vehicle height direction.

The above-described various devices or sensors constituting the vehicle control system 1 are connected as nodes to an in-vehicle network Nw which is a communication network constructed in the vehicle. Nodes connected to the in-vehicle network Nw can communicate with one another. Some specific devices may be configured to directly communicate with one another without using the in-vehicle network Nw. As the standard of in-vehicle network Nw, for example, various standards such as Controller Area Network (CAN is a registered trademark) and Ethernet (registered trademark) can be adopted.

The front camera 11 captures an image in front direction of the vehicle at a predetermined angle of view. For example, the front camera 11 is disposed on an upper end portion of a windshield on the vehicle interior side, a front grille, a roof top, or the like. As shown in FIG. 3, the front camera 11 includes a camera body 111 and a camera ECU 112. The camera body 111 is provided by a module including at least an image sensor and a lens. The camera body 111 generates captured image data at a predetermined frame rate such as 30 fps or 60 fps. The camera ECU 112 detects a predetermined detection target by performing recognition processing on the image frame generated by the camera body 111. The camera ECU 112 is implemented by an image processing chip, which includes a central processing unit (CPU), a graphics processing unit (GPU), and the like.

The camera ECU 112 detects a predetermined object based on image information including color, brightness, contrast related to color and brightness, and the like. The camera ECU 112 includes an identifier E1 as a functional block. The identifier E1 is configured to identify the type of an object based on a feature vector of an image generated by the camera body 111. For example, a CNN (Convolutional Neural Network), a DONN (Deep Neural Network), or the like to which deep learning is performed may be used as the identifier E1.

The detection target of the camera ECU 112 may be appropriately set. For example, the camera ECU 112 detects a road edge, a predetermined road marking, and a traffic sign. The road marking set as the detection target may be a lane marking, a temporary stop line, an arrow paint indicating a traveling direction at an intersection, or the like. The camera ECU 112 can recognize the curvature, the width, and the like of the road based on the regression curve of the detection points indicating the lane markings and the road edges.

The camera ECU 112 can also detect moving objects such as pedestrians and other vehicles. Other vehicles include bicycles (also referred to as cyclists), bicycles with motors, and motorcycles. The camera ECU 112 specifies a host vehicle lane, which is a lane in which the host vehicle is traveling, based on the recognition result of the lane markings existing on the left side and the right side of the host vehicle, and recognizes another vehicle existing in front of the host vehicle on the host vehicle lane as a preceding vehicle. Then, the distance and the relative speed with respect to the preceding vehicle are specified.

The front camera 11 is configured to detect the traffic signal 9. When the front camera 11 recognizes the traffic signal 9, the front camera 11 recognizes at least the color of activated light element (that is, the color of turned-on light element). Among multiple light elements included in the traffic signal 9, the activated light element in the present disclosure refers to a light element that emits light or a light element that has been turned on. The light element refers to a device itself capable of emitting light, that is, a lighting device.

The recognition result of the traffic signal 9 by the front camera 11 includes relative position information of the traffic signal with respect to the host vehicle and lighting state information indicating a lighting state. The lighting state information mainly indicates a combination of lighting colors. The combination of lighting colors is not limited to the case of including multiple colors such as red and green, but also includes a variation in which there is only one lighting color such as only red or only green. When a red light element, a green arrow light for straight traveling, and a green arrow light for left turn are turned on at the same time, the lighting state information can include information indicating the quantity of activated light elements in what color, such as one red light and two green lights.

When the shape of activated light element of the traffic signal 9 can be specified, the camera ECU 112 can output the recognized shape information. As the shape of activated light element, a circle or an arrow is assumed. In response to determining that the shape of activated light element is an arrow, the direction in which the arrow is directed is also acquired. The lighting state information of the traffic signal 9 may include a set of color and shape of the activated light element. When the shape of activated light element cannot be specified, the camera ECU 112 may insert a predetermined value indicating that the shape is unknown into the data field indicating the shape of activated light element. The camera ECU 112 may recognize the center coordinates of housing, the arrangement type, the size information, the green arrow light information, and the like of the traffic signal, and output the recognition result to the drive assist ECU 20.

When the camera ECU 112 detects multiple traffic signals 9, the camera ECU 112 distinguishes the traffic signal 9 for the host vehicle from other traffic signals 9 by using a flag or the like and outputs the multiple traffic signals in distinguishable manner. The traffic signal 9 for the host vehicle is the traffic signal 9 corresponding to the host vehicle lane, in other words, the traffic signal 9 that the host vehicle should follow. The traffic signal 9 for the oncoming vehicle and the traffic signal 9 for the crossing vehicle do not correspond to the traffic signal 9 for the host vehicle. The crossing vehicle refers to a vehicle traveling on another road connected to the road on which the host vehicle is traveling. For example, a vehicle coming from in lateral direction at an intersection corresponds to a crossing vehicle. In an area where the traffic signal 9 is provided for each lane, the traffic signal 9 on the host vehicle lane corresponds to the traffic signal 9 for the host vehicle, and the traffic signal 9 for the adjacent lane does not correspond to the traffic signal 9 for the host vehicle. In an area where one traffic signal 9 is provided as the traffic signals for multiple lanes, the nearest traffic signal among the traffic signals 9 that are present on the extension line of the host vehicle traveling road and whose housings face the host vehicle may be determined as the traffic signal 9 for the host vehicle.

When multiple traffic signals 9 are detected, the camera ECU 112 may adopt the traffic signal 9 present in the front direction of the host vehicle or the traffic signal 9 present above the host vehicle lane as the traffic signal 9 for the host vehicle. When the camera ECU 112 detects multiple traffic signals 9, the camera ECU 112 may adopt, as the traffic signal 9 for the host vehicle, the traffic signal 9 which is located in front of the host vehicle and whose housing faces the host vehicle. When multiple traffic signals 9 for the host vehicle are detected, the nearest traffic signal 9 may be adopted as the traffic signal 9 for the host vehicle to be used for traveling control. The drive assist ECU 20 may determine whether the detected traffic signal 9 is the traffic signal corresponding to the host vehicle lane, instead of the camera ECU 112.

Partial or entire of the planimetric features to be detected by the front camera 11 are used as landmarks in the drive assist ECU 20. The landmark refers to a planimetric feature that can be used as a mark for specifying the position of host vehicle on the map. As the landmark, for example, at least one of a signboard corresponding to a traffic sign such as a regulation sign or a guide sign, the traffic signal 9, a pole, a guide board, a temporary stop line, a boundary line, and the like can be adopted. In the present disclosure, a linear landmark continuously extending along a road, such as a lane marking or a road edge, is referred to as a continuous landmark. In contrast to the continuous landmarks, landmarks discretely arranged along a road, such as traffic signs, temporary stop lines, fire hydrants, and manholes, are referred to as discrete landmarks. The discrete landmarks correspond to scattered planimetric features.

The camera ECU 112 outputs signals indicating a relative position, a type, and a moving speed of each detected object, a configuration of the detected object, and the like. An output signal from the camera ECU 112 is input to the drive assist ECU 20 via the in-vehicle network Nw. The detection result of the front camera 11 may be referred to as a recognition result or an identification result.

The functions of the camera ECU 112, such as the object recognition process based on the image data, may be included in another ECU, such as the drive assist ECU 20. In this case, the front camera 11 may provide image data as observation data to the drive assist ECU 20. The functional arrangement of the vehicle control system 1 may be changed as appropriate.

The vehicle state sensor 12 is a sensor group that detects state quantities related to travel control of the host vehicle. The vehicle state sensors 12 include a vehicle speed sensor, a steering sensor, an acceleration sensor, a yaw rate sensor, an accelerator sensor, a brake sensor, and the like. The vehicle speed sensor detects a travel speed of the host vehicle. The steering sensor detects a steering angle of the host vehicle. The acceleration sensor detects an acceleration such as longitudinal acceleration and a lateral acceleration of the host vehicle. The yaw rate sensor detects an angular velocity of the host vehicle. The accelerator sensor detects a depression amount/depression force applied to an accelerator pedal. The brake sensor detects a depression amount/depression force applied to a brake pedal. The type of the sensor used by the vehicle control system 1 as the vehicle state sensor 12 may be appropriately designed, and it is not necessary to include all of the sensors described above. The vehicle state sensor 12 also includes a sensor that detects an operation of the driver. The vehicle state sensor 12 may include a rain sensor that detects rainfall and an illuminance sensor that detects outside brightness.

The locator 13 is a device that generates position information of the host vehicle by complex positioning combining multiple pieces of information. The locator 13 may be implemented by a GNSS receiver. The GNSS receiver is a device that sequentially detects a current position of the GNSS receiver by receiving a navigation signal transmitted from a positioning satellite constituting a global navigation satellite system (GNSS). For example, when the GNSS receiver can receive navigation signals from four or more positioning satellites, the GNSS receiver outputs a positioning result every 100 milliseconds. For example, GPS, Galileo, IRNSS, QZSS, BeiDou, or the like can be adopted as the GNSS.

The locator 13 sequentially measures the position of host vehicle by combining the positioning result of the GNSS receiver and the output signals from inertial sensors. For example, when the GNSS receiver cannot receive the GNSS signal, such as in a tunnel, the locator 13 performs dead reckoning (that is, autonomous navigation) using vehicle speed, yaw rate, and acceleration information input from various vehicle state sensors 12. The position information as the positioning result is output to the in-vehicle network Nw and used by the drive assist ECU 20 and the like. Partial function of the locator 13 may be included in the drive assist ECU 20.

The V2X vehicle-mounted device 14 enables the host vehicle to perform wireless communication with another device. The V2X vehicle-mounted device 14 includes a cellular communication unit and a dedicated short range communication unit as communication modules. The cellular communication unit is a communication module for performing wireless communication conforming to a predetermined wide-area wireless communication standard. As the wide-area wireless communication standard, various standards such as LTE (Long Term Evolution), 4G, and 5G can be adopted. The communication module as the cellular communication unit may also be referred to as a telematics control unit (TCU) or a data communication module (DCM).

Note that the cellular communication unit may be configured to be capable of directly performing wireless communication with another device using a communication method conforming to a wide-area wireless communication standard, in addition to communication via the wireless base station. The cellular communication unit may be configured to perform cellular V2X (PC5/uGu). The host vehicle becomes a connected car connectable to the Internet by mounting the V2X vehicle-mounted device 14. For example, the drive assist ECU 20 can download and use map data corresponding to the current position from the map distribution server 4 in cooperation with the V2X vehicle-mounted device 14.

The dedicated short-range communication unit included in the V2X vehicle-mounted device 14 is a communication module that performs dedicated short-range communication which enables wireless communication within a range of several hundred meters. The dedicated short range communication may be implemented by a dedicated short range communications (DSRC) corresponding to the IEEE802.11p standard or Wi-Fi (registered trademark). The dedicated short-range communication may be implemented by the above-described cellular V2X. One of the cellular communication unit or the dedicated short range communication unit may be omitted as appropriate. When the V2X vehicle-mounted device 14 does not have a cellular communication function, the drive assist ECU 20 may acquire map data or the like from a roadside device or another vehicle by a short-range communication function.

The HMI system 15 functions as an input interface that receives a user operation and also functions as an output interface that presents information to the user. The HMI system 15 includes a display 151, a speaker 152, and an HMI control unit (HCU) 153. As means for presenting information to the user, in addition to the display 151 and the speaker 152, a vibrator, an illumination device, or the like can be adopted.

The display 151 displays an image corresponding to a signal input from the HCU 153. For example, the display 151 may be a center display located at an uppermost and central portion of an instrument panel in width direction of the vehicle. The display 151 may support full-color display. The display 151 is implemented by using, for example, a liquid crystal display, an organic light emitting diode (OLED) display, or the like. The display 151 may be a meter display provided in front of the driver seat. The display 151 may be a head-up display that projects a virtual image on a part of the windshield in front of the driver seat. The speaker 152 outputs a sound corresponding to a signal input from the HCU 153. The expression “sound” includes voice, music, and the like in addition to a notification sound.

The HCU 153 is configured to integrally control information presentation to the user. The HCU 153 may be implemented by using, for example, a processor such as a CPU or a GPU, a random access memory (RAM), a flash memory, and the like. The HCU 153 controls a display window of the display 151 based on information provided from the drive assist ECU 20 and a signal from an input device (not shown). The input device refers to a touch panel arranged on the display 151, a steering switch, a voice input device, or the like. The HCU 153 displays an icon image indicating the recognition state of traffic signal 9 on the display 151 based on a request from the drive assist ECU 20.

The traveling actuator 16 is an actuator used for traveling. For example, the traveling actuator 16 includes a brake actuator as a braking device, an electronic throttle, a steering actuator, and the like. The steering actuator also includes an electric power steering (EPS) motor. The traveling actuator 16 is controlled by the drive assist ECU 20. Other ECU s such as a steering ECU that performs steering control, a power unit control ECU that performs acceleration/deceleration control, and a brake ECU may be interposed between the drive assist ECU 20 and the traveling actuator.

The drive assist ECU 20 assists the driving operation of driver seat occupant based on the detection result of the front camera 11. For example, the drive assist ECU 20 controls the traveling actuator 16 based on the detection result of the front camera 11 to execute partial or entire of the driving operation instead of the occupant in the driver seat. The drive assist ECU 20 may be an autonomous driving device that controls the host vehicle to autonomously travel in response to an autonomous travel instruction input by the user.

The drive assist ECU 20 mainly includes a computer, which includes a processor 21, a RAM 22, a storage 23, a communication interface 24, and a bus connecting these components. The processor 21 is provided by a hardware that performs arithmetic processing. The hardware is connected with the RAM 22. The processor 21 includes at least one arithmetic core such as a CPU. The processor 21 executes various processes by accessing the RAM 22. The storage 23 is a memory device using a non-volatile storage medium such as a flash memory or an EEPROM (registered trademark, Electrically Erasable Programmable Read-Only Memory). The storage 23 stores a driving assistance program as a program executed by the processor 21. Execution of the program by the processor 21 corresponds to execution of a driving assistance method as a method corresponding to the driving assistance program. The communication interface 24 is a circuit for communicating with other devices via the in-vehicle network Nw. The communication interface 24 may be implemented by an analog circuit element, an IC, or the like.

### Drive Assist ECU 20

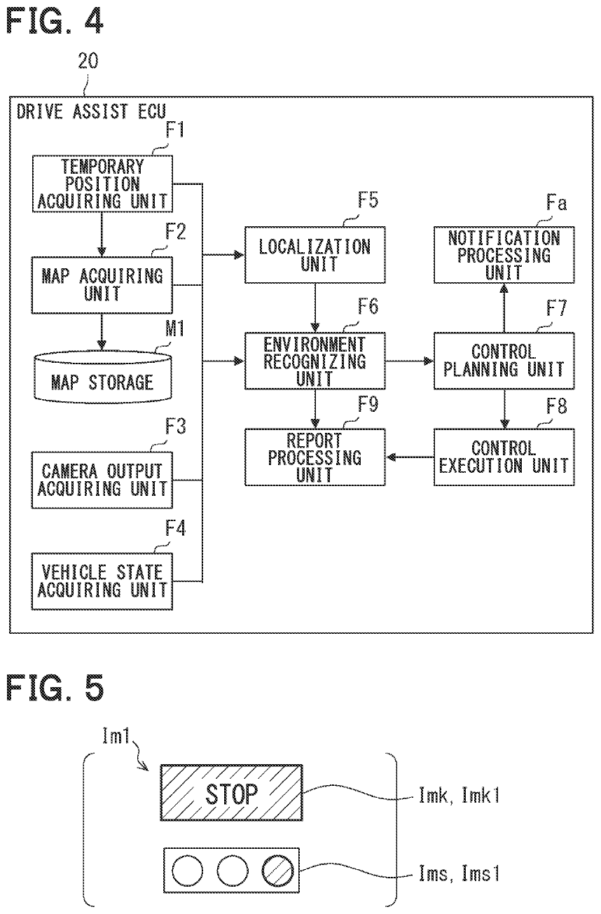

The following will describe functions and operations of the drive assist ECU 20 with reference to FIG. 4. The drive assist ECU 20 provides functions corresponding to various functional blocks illustrated in FIG. 4 by the processor 21 executing the driving assist program stored in the storage 23. That is, the drive assist ECU 20 includes, as functional blocks, a temporary position acquiring unit F1, a map acquiring unit F2, a camera output acquiring unit F3, a vehicle state acquiring unit F4, a localization unit F5, an environment recognizing unit F6, a control planning unit F7, a control execution unit F8, and a report processing unit F9.

The temporary position acquiring unit F1 acquires, from the locator 13, host vehicle position information, which indicates the position coordinates of host vehicle. The temporary position acquiring unit F1 may have the function of the locator 13. The temporary position acquiring unit F1 can sequentially perform dead reckoning based on an output of a yaw rate sensor or the like with the host vehicle position calculated by the localization unit F5 described later as a start point.

The map acquiring unit F2 acquires map data corresponding to the current position of host vehicle by performing wireless communication with the map distribution server 4 via the V2X vehicle-mounted device 14. For example, the map acquiring unit F2 requests the map distribution server 4 to provide partial map data related to a road on which the host vehicle is scheduled to pass within a predetermined time. The map data acquired from the map distribution server 4 is stored in, for example, a map storage M1. The map data is downloaded in a predetermined distribution unit such as a map tile.

The map storage M1 may be implemented by using partial storage area of the storage 23 or partial storage area of the RAM 22. The map storage M1 may be implemented by using a non-transitory tangible storage medium. As described above, the map data includes the installation position of traffic signal 9 and the passable pattern data for each intersection. Since the passable pattern data corresponds to the traffic signal response policy data, the map acquiring unit F2 corresponds to a response policy data receiving unit.

The camera output acquiring unit F3 acquires a recognition result of the front camera 11 for a planimetric feature, another moving object, or the like. Specifically, the camera output acquiring unit F3 acquires the position, the moving speed, the type, the size, and the like of another moving object. When the camera ECU 112 is configured to identify a preceding vehicle, the camera output acquiring unit F3 acquires preceding vehicle information from the camera ECU 112. The preceding vehicle information can include the presence or absence of a preceding vehicle, an inter-vehicle distance relative to the preceding vehicle, a relative speed, and the like.

When the camera ECU 112 recognizes the traffic signal 9, the camera output acquiring unit F3 acquires information on the traffic signal for the host vehicle. For example, the camera output acquiring unit F3 acquires, from the camera ECU 112, the recognition result related to the position and the lighting state of the traffic signal 9 for the host vehicle. The camera output acquiring unit F3 may acquire relative position coordinates and types of landmarks, such as traffic signs, lane markings, and road edges, from the front camera 11. Both or either one of the camera output acquiring unit F3 and the camera ECU 112 corresponds to a lighting state acquiring unit.

The vehicle state acquiring unit F4 acquires a traveling speed, a traveling direction, time information, weather, illuminance outside the vehicle compartment, an operation speed of wiper, a shift position, and the like from the vehicle state sensor 12 via the in-vehicle network Nw. The vehicle state acquiring unit F4 acquires operation information that indicates a driving operation performed by the driver. For example, the vehicle state acquiring unit F4 acquires a depression state of a brake pedal or a depression state of an accelerator pedal as the operation information. The depression state includes the presence or absence of depression and the depression amount/depression force applied to the pedal.

The localization unit F5 executes localization processing based on the landmark information and the map information acquired by the camera output acquiring unit F3. The localization process specifies the detailed position of host vehicle by comparing the position of landmark specified based on the image captured by the front camera 11 with the position coordinates of a planimetric feature registered in the map data. The localization unit F5 can convert the relative position coordinates of the landmark acquired from the camera ECU 112 into position coordinates (hereinafter, also referred to as observation coordinates) in the global coordinate system as a preparation process for localization. For example, the observation coordinates of landmark are calculated by combining the current position coordinates of the host vehicle and the relative position information of the planimetric feature with respect to the host vehicle. The camera ECU 112 may calculate the observation coordinates of the landmark using the current position coordinates of the host vehicle.

The localization unit F5 associates the landmark registered in the map with the landmark observed by the front camera 11 based on the observation coordinates of each landmark. The association (matching) between the observed landmark and the landmark registered in the map can be performed using the position coordinates and the type information. At the time of matching the landmarks, it may be configured to adopt a landmark having a higher matching degree of features by using feature amounts such as a shape, a size, and a color.

When the association between the observed landmark and the landmark on the map is completed, the localization unit F5 performs longitudinal position estimation using the information of distance to the observed discrete landmarks. The longitudinal position estimation corresponds to a process of specifying the host vehicle position in an extending direction of road. For example, the localization unit F5 sets, as the host vehicle position in the extending direction of road, a position shifted from the position coordinates of the landmark on the map, which corresponds to the observed discrete landmark, by the observation distance of the host vehicle with respect to the landmark in the direction opposite to the traveling direction. For example, in a situation where the distance to a direction signboard present in front of the host vehicle is specified to be 40 meters as a result of image recognition, it is determined that the host vehicle is located at a position shifted to a rear direction of the vehicle by 40 meters from the position coordinates of the direction signboard registered in the map data. By performing such longitudinal position estimation, a detailed remaining distance to a feature point on a road, in other words, a POI, such as an intersection, a curve entrance/exit, a tunnel entrance/exit, or the end of a traffic jam, can be specified.

As the lateral position estimation processing, the localization unit F5 specifies the lateral position of host vehicle with respect to the road based on the distances from the left and right road edges/lane markings recognized by the front camera 11. For example, when the distance from the left road edge to the vehicle center is specified as 1.75 meters as a result of the image recognition, it is determined that the host vehicle is present at a position shifted by 1.75 meters to the right side from the coordinates of the left road edge. The localization unit F5 can specify the host vehicle lane ID, which is an identifier of the host vehicle lane, based on the distance from the left and right road edges recognized by the front camera 11 or based on the number/line type of lane markings existing lateral side of the host vehicle. The host vehicle lane ID indicates in which lane the host vehicle is traveling from the left or right road edge. The host vehicle lane ID can also be referred to as a host vehicle lane number. The host vehicle lane can also be referred to as an ego lane. The localization unit F5 corresponds to a host vehicle lane recognition unit.

The function of specifying the host vehicle lane number may be implemented by another ECU, such as the camera ECU 112. The host vehicle lane recognition unit may be configured to acquire a host vehicle lane number determined by another ECU. The configuration of acquiring the host vehicle lane number determined by another ECU also corresponds to the configuration of recognizing the host vehicle lane corresponds to which lane when counted from the right or left road edge.

The localization unit F5 sequentially performs localization processing at a predetermined position estimation cycle. The default value of position estimation period may be 200 milliseconds or 400 milliseconds. For example, the localization unit F5 sequentially performs the longitudinal position estimation process as long as the discrete landmark is recognized (in other words, captured). Even when the discrete landmark is not recognized, the localization unit F5 may sequentially perform the lateral position estimation process as long as at least one of the lane marking or the road edge is recognized. The host vehicle position as a result of the localization processing is expressed by a coordinate system, similar to that of the map data, for example, latitude, longitude, and altitude. The host vehicle position information calculated by the localization unit F5 is provided to the temporary position acquiring unit F1, the environment recognizing unit F6, and the like.

The environment recognizing unit F6 recognizes the periphery environment, which is the environment around the host vehicle, mainly based on the recognition result of the front camera 11. The recognition result of the front camera is acquired by the camera output acquiring unit F3. The periphery environment includes the current position of host vehicle, the lane of host vehicle, the road type, the speed limit, and the relative position of the traffic signal 9 and the like. When there is a traffic signal 9 in front of the host vehicle, the lighting state of traffic signal 9 is also included in the periphery environment. The periphery environment may include the position and moving speed of another moving body, the shape and size of a periphery object, and the like. The environment recognizing unit F6 may be integrated with the camera output acquiring unit F3.

The environment recognizing unit F6 determines whether the lighting state of traffic signal existing in front of the host vehicle indicates the passable pattern using the passable pattern data of the corresponding traffic signal included in the map data. Specifically, the environment recognizing unit F6 determines whether the lighting state of traffic signal existing in front of the host vehicle indicates the passable pattern based on the passable pattern data of the corresponding traffic signal included in the map data, the host vehicle lane number, and the lighting state of traffic signal recognized by the front camera 11. The environment recognizing unit F6 corresponds to a passing propriety determination unit. The passing propriety determination function may be included in the control planning unit F7. The functional arrangement may be changed as appropriate.

The environment recognizing unit F6 may acquire detection results from each of multiple periphery monitoring sensors and combine the detection results to recognize the position and type of an object existing around the host vehicle. The periphery monitoring sensor recognizes an object existing outside the vehicle, and may be provided by a millimeter wave radar, a LiDAR, or the like. A camera that captures images of the outside of the vehicle, such as the front camera 11, also corresponds to the periphery monitoring sensor.

For example, the environment recognizing unit F6 may recognize the periphery environment by using both the recognition result of the front camera 11 and the detection result of a distance measuring sensor. More specifically, the environment recognizing unit F6 may specify the inter-vehicle distance and the relative speed with respect to the preceding vehicle using the detection result of distance measuring sensor included in the front system. The distance measuring sensor corresponds to the periphery monitoring sensor that detects an object in a detection range by transmitting and receiving exploration waves, such as a millimeter wave radar, a LiDAR, or a sonar. The distance measuring sensor in the front system refers to a distance measuring sensor whose detection range includes a front range of the host vehicle.

The environment recognizing unit F6 may specify the periphery environment using other vehicle information, which is received by the V2X vehicle-mounted device 14 from other vehicles, traffic information received from a roadside device by road-to-vehicle communication, or the like. The traffic information that can be acquired from the roadside device may include road construction information, traffic regulation information, congestion information, weather information, speed limit, and the like. The environment recognizing unit F6 can recognize the travel environment by integrating information indicating the external environment input from multiple devices.

The control planning unit F7 generates a vehicle control plan using the traveling environment recognized by the environment recognizing unit F6 and the map data, for assisting the driving operation of the user. For example, when it is confirmed that the traffic signal 9 is present in front of the host vehicle, the control planning unit F7 generates a vehicle control plan according to the lighting state of the traffic signal 9. For example, when the lighting state of traffic signal 9 at the time when the host vehicle reaches 100 meters before the traffic signal 9 corresponds to a stop pattern, a travel plan for decelerating the host vehicle so as to stop at a predetermined distance before the traffic signal 9 is generated. The stop pattern corresponds to a lighting pattern in which entry into the intersection is prohibited. When there is no preceding vehicle or when the inter-vehicle distance to the preceding vehicle is equal to or greater than a predetermined value, the stop position as a response to the lighting state of the traffic signal 9 can be set at a location corresponding to the temporary stop line indicated in the map data.

When the traffic signal 9 corresponds to the stop pattern in a situation where there is a preceding vehicle, the control planning unit F7 may update the control plan as needed so that the vehicle stops behind the preceding vehicle by a predetermined distance. When the lighting state of the traffic signal 9 corresponds to the passable pattern, a control plan for passing through the intersection is generated. The passable pattern is a lighting state that permits the host vehicle to enter and pass through the intersection. The expression “passable” can be rephrased as “possible to enter an intersection”. Further, the expression “not passable” can be rephrased as “prohibited from entering an intersection” or “prohibited from passing through an intersection”. The lighting state in which the vehicle is permitted to enter and pass through the intersection includes a case where a green arrow light corresponding to the traveling direction of the host vehicle lane is turned on in addition to a case where a circular green light is turned on.

The control plan as the system response to the lighting state of the traffic signal 9 is generated based on the lighting state of the traffic signal 9 at the time when the host vehicle reaches a predetermined distance (for example, 100 meters or 50 meters) before the traffic signal 9. The control plan can be updated as needed in response to a change in the lighting state or the like. For the sake of convenience, vehicle control for assisting traveling when passing through a road on which the traffic signal 9 is provided is referred to as traffic signal passing assistance. The traffic signal passing assistance includes automatic adjustment of traveling speed, for example, execution of brake control for stopping the host vehicle before the traffic signal 9. The traffic signal passing assistance may be a process of notifying the user of the presence of traffic signal 9 and the lighting state of traffic signal 9 in cooperation with the HMI system 15. The control plan of traffic signal passing assistance can be updated at proper time in response to a change in the lighting state of traffic signal 9.

The control planning unit F7 may create a control plan including a control schedule of the steering amount for traveling within a center region of the recognized host vehicle traveling lane, or may generate a route following a behavior or traveling trajectory of the recognized preceding vehicle as the travel plan. The drive assist ECU 20 is able to perform preceding vehicle following control for controlling traveling of the host vehicle such that the host vehicle follows a preceding vehicle while maintaining a predetermined distance from the preceding vehicle. The travel plan may include acceleration/deceleration schedule information for speed adjustment on the calculated route and control schedule information of steering angle.

The control execution unit F8 outputs a control signal, which corresponds to the control plan determined by the control planning unit F7, to the traveling actuator 16 and/or the HCU 153. The traveling actuator and the HCU 153 correspond to control targets. For example, when deceleration is scheduled, a control signal for implementing the planned deceleration is output to a brake actuator or an electronic throttle. In addition, a control signal for outputting an image or sound indicating the execution state of the traffic signal passing assistance is output to the HCU 153. The control planning unit F7, the control execution unit F8, and a notification processing unit Fa correspond to a response unit.

The report processing unit F9 transmits a data set, in which a recognition result related to the lighting state of traffic signal 9 for the host vehicle is associated with host vehicle behavior data indicating the behavior of the host vehicle, to the map generation server 3 as a traffic signal response report. The operation of the report processing unit F9 will be described below.

The notification processing unit Fa executes a process of notifying the driver of the recognition result of traffic signal 9 and the determination result of passing propriety corresponding to the recognition result. The notification can be implemented by displaying an image on the display 151 or outputting a voice message from the speaker 152. The notification processing unit Fa may display, on the display 151, an entry prohibition image Im1 indicating that the vehicle should stop, in other words, entry is prohibited. The notification processing unit Fa may display, on the display 151, an entry possible image Im2 indicating that passing is possible. These images are displayed as images accompanying the recognition result of the lighting state of traffic signal 9. The notification processing unit Fa performs image display related to the recognition result of the traffic signal 9 and the determination result of passing propriety on condition that the remaining distance Drm to the intersection where the traffic signal 9 is located is less than a control continuation determination distance Dcn to be described later. Various notification processes performed by the notification processing unit Fa are performed according to the plan generated by the control planning unit F7. The drive assist ECU 20 may include the notification processing unit Fa as a part of the control execution unit F8.

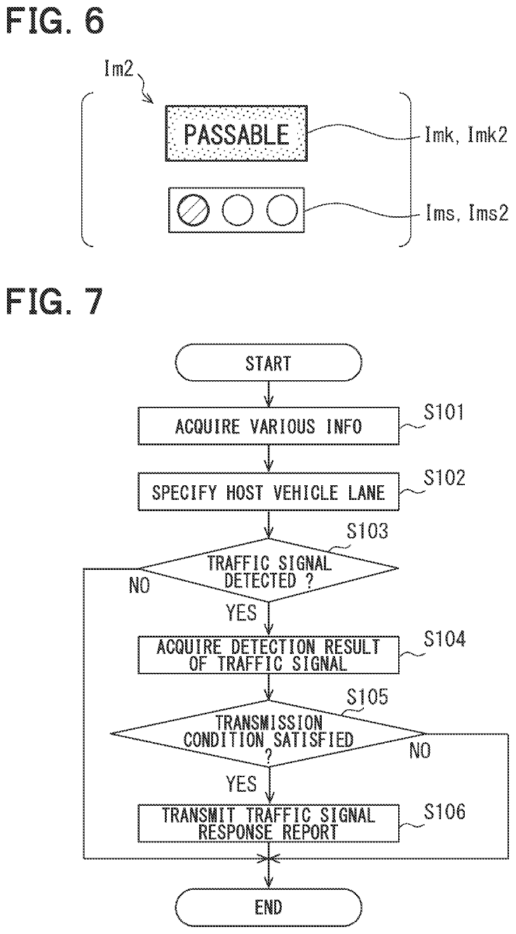

Each of the entry prohibition image Im1 and the entry possible image Im2 can include a recognition result image Ims indicating a recognition result of the traffic signal lighting state and a determination result image Imk indicating passing propriety. For example, as shown in FIG. 5, the entry prohibition image Im1 may include a stop instruction mark Imk1 and a red signal icon Ims1. As illustrated in FIG. 6, the entry possible image Im2 may include a passable mark Imk2 and a green signal icon Ims2. The stop instruction mark Imk1 and the passable mark Imk2 correspond to the determination result image Imk. The red signal icon Ims1 and the green signal icon Ims2 correspond to the recognition result image Ims. The notification processing unit Fa may select, from a display image database prepared in advance, an image suitable for the shape/arrangement type of the recognized actual traffic signal 9, and display the selected image as the recognition result image Ims. For example, when a green arrow light is recognized, an icon image of the traffic signal 9 including the green arrow light may be properly selected and displayed. The character string included in the passable mark Imk2 is not limited to “PASSABLE” and may be, for example, “GO”. The text included in these images can be converted into an official language conforming to a usage region. The determination result image Imk may be a diagram (also known as a pictogram) or the like that does not include text or expression whether or not passage is permitted.

The information, which the drive assist ECU 20 should present to the driver as the image indicating the system operation state related to intersection passing assistance, includes two information items, that is, (1) the presence of traffic signal 9 in front of the host vehicle and (2) the determination result of whether to proceed toward or stop before the traffic signal. A specific recognition result that can be presented by the recognition result image Ims is an arbitrary element. Instead of the traffic signal image reflecting the recognized lighting state of the traffic signal 9, the notification processing unit Fa may display an icon image imitating only the shape or the arrangement type of traffic signal 9 in parallel with the determination result image.

### Operation Flow of Report Processing Unit F9

The following will describe a traffic signal response report process executed by the report processing unit F9 with reference to the flowchart shown in FIG. 7. The flowchart illustrated in FIG. 7 is executed at a predetermined cycle (for example, every 200 milliseconds) while the traveling power supply of the vehicle is in turn-on state. The traveling power supply may be provided by ignition power source in an engine vehicle. In an electrically powered vehicle such as an electric vehicle or a plug-in hybrid vehicle, a system main relay provides the traveling power supply. In the present embodiment, as an example, the traffic signal response report process includes S101 to S106. Note that the flowcharts in the present disclosure are only examples, and the number of steps, the processing order, the execution conditions, and the like can be changed as appropriate.

The localization unit F5 of the drive assist ECU 20 successively performs the localization process independently of the flowchart illustrated in FIG. 7. That is, the localization unit F5 successively performs the localization process in parallel with the process shown in FIG. 7. Specifically, the localization unit F5 successively performs the localization process using the landmark. By performing the localization process, the detailed position of host vehicle on the map can be determined.

First, in S101, the environment recognizing unit F6 recognizes the traveling environment based on signals from the front camera 11 and the like. In S101, the environment recognizing unit F6 acquires traffic signal information, preceding vehicle information, a recognition result of lane marking, and the like. The traffic signal information includes presence or absence of traffic signal 9, a remaining distance to the traffic signal 9 when the traffic signal 9 is present, the lighting state of traffic signal 9, and the like. The preceding vehicle information includes presence or absence of a preceding vehicle. When a preceding vehicle is determined to be present, the preceding vehicle information further includes an inter-vehicle distance and relative speed with respect to the preceding vehicle and the lighting state of lighting device of the preceding vehicle. The lighting state of lighting device refers to a lighting state of a direction indicator, a brake light element, or the like. In S101, the process acquires behavior of host vehicle, such as the vehicle speed and yaw rate of the host vehicle and the operation information of the driver.

In S102, the localization unit F5 specifies the vehicle position coordinates and the vehicle lane ID based on the input signal from the front camera 11. S102 may be integrated with S101.

In S103, the environment recognizing unit F6 determines whether the traffic signal 9 for the host vehicle is detected by the front camera 11. When the traffic signal 9 for the host vehicle is not detected, the process determines NO in S103, and the flow is ended. When the traffic signal 9 for the host vehicle is detected in S103, the process proceeds to S104. The map data may be used to identify whether the detected traffic signal 9 is the traffic signal 9 for the host vehicle. The environment recognizing unit F6 may determine whether the traffic signal 9 detected by the front camera 11 is the traffic signal 9 for the host vehicle on the basis of information on the position, the size, the arrangement type, the presence or absence of an auxiliary light related to the traffic signal 9 indicated in the map data.

In S104, the camera output acquiring unit F3 acquires the recognition result of lighting state of traffic signal 9 for the host vehicle. For example, the color of activated light element is acquired. If multiple light elements are in activated states, the lighting color of each activated light element is acquired. The camera output acquiring unit F3 may acquire the shape of activated light element, for example, a circle or an arrow, when the shape information is available. The camera output acquiring unit F3 may acquire the location of activated light element with respect to the housing of traffic signal when the location information is available.

In S105, the report processing unit F9 determines whether a transmission condition is satisfied. The transmission condition is a condition for transmitting the traffic signal response report. When the transmission condition is satisfied, the report processing unit F9 transmits the traffic signal response report in S106. The traffic signal response report is a data set indicating whether the host vehicle/another vehicle has stopped or passed, that is, how the host vehicle/another vehicle has responded to the lighting state of traffic signal 9 for the host vehicle.

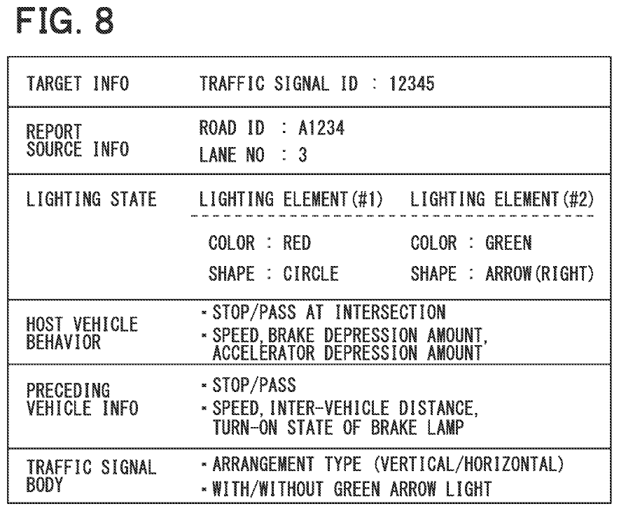

The traffic signal response report is a data set indicating a combination of colors of activated light elements in the traffic signal 9 and the behavior of host vehicle with respect to the combination. For example, as illustrated in FIG. 8, the traffic signal response report may include target information, report source information, lighting state information, host vehicle behavior information, and preceding vehicle information. The target information specifies the traffic signal 9 for which the map generation server 3 is required to generate the report. For example, the target information is represented by a traffic signal ID, that is, a unique identification number assigned to each traffic signal 9. The target information may be expressed by a combination of the position coordinates of traffic signal 9 and the traveling direction. The report source information may include information under which the map generation server 3 can specify the vehicle on which lane has transmitted the report. For example, the report source information can be expressed by the lane ID of host vehicle. The report source information may include a road link ID or a traveling direction in addition to the lane ID in which the vehicle as the report source is traveling.

The lighting state information is information on a combination of colors of activated light elements of the traffic signal 9. The lighting state information may include the quantity of activated light elements. When the shape of activated light element is recognized, the lighting state information may include shape information of the activated light element. When the shape of activated light element cannot be acquired due to an environmental factor, such as rainfall, the report processing unit F9 may report that the shape is unknown. When the traffic signal 9 for the host vehicle includes a green arrow light and the green arrow light is in activated state, that is, turned-on state, the traffic signal response report may include information indicating the color and the direction of activated green arrow light. The behavior data of host vehicle included in the traffic signal response report indicates the behavior of host vehicle with respect to the intersection, in other words, in response to the lighting state of traffic signal. The behavior data of host vehicle included in the traffic signal response report may indicate whether the host vehicle stopped before the intersection or whether the host vehicle passed the intersection without stopping. The report processing unit F9 may subdivide the behavior of host vehicle with respect to the lighting state of traffic signal into several phases, such as, whether the host vehicle has stopped before the intersection for a predetermined second or more, whether the host vehicle has passed the intersection without temporary stop, whether the host vehicle has passed the intersection after making a temporary stop, and report the behavior of host vehicle. Note that the temporary stop here is a stop for checking traffic conditions, and can be a stop for less than five seconds, for example. The host vehicle behavior data may include time-series data such as a vehicle speed, a depression amount of brake pedal, and a depression amount of accelerator pedal within a past predetermined period from a stop time point or a passing time point at the intersection. Instead of or in parallel with the time-series data of the depression amount of brake/accelerator pedal, time-series data of acceleration may be included in the host vehicle behavior data.

The traffic signal response report may include preceding vehicle information, such as an inter-vehicle distance to the preceding vehicle and a lighting state of a brake light element of the preceding vehicle. As another aspect, the traffic signal response report may include relative position information of the activated light element with respect to the housing of traffic signal. In other words, the traffic signal response report may include information indicating which light element is activated in what color. The traffic signal response report may include configuration information, such as an arrangement type and presence or absence of green arrow light as reference information related to the traffic signal 9. Arrangement type refers to vertical or horizontal arrangement of the light elements in the traffic signal.

As the transmission condition of traffic signal response report, it is possible to adopt that the remaining distance to the traffic signal 9 is equal to or less than a predetermined report distance. The report distance may be set to, for example, 10 meters, 15 meters, 20 meters, or 50 meters. The report distance is set to a value at which the recognition accuracy of lighting state of traffic signal 9 is expected to be equal to or greater than a predetermined value. The transmission condition is set to be able to suppress transmission of information that may become noise, in other words, information that is less useful/unnecessary, when traffic signal response policy data to be described later is generated.

Even when the remaining distance to the traffic signal 9 is equal to or greater than the report distance, the report processing unit F9 may transmit the traffic signal response report when the host vehicle stops before the traffic signal 9 or when the driver's brake operation is detected. The report processing unit F9 may transmit the traffic signal response report in response to the driver operation contrary to the automatic control content being detected in a state where the automatic speed adjustment control is executed by the drive assist ECU 20. The driver's operation in the preceding vehicle following control is also referred to as override operation. For example, when depression of accelerator by the driver is detected during automatic deceleration for stopping before the traffic signal, the traffic signal response report may be transmitted. The traffic signal response report may be transmitted with detection of the driver's brake operation as a trigger during execution of preceding vehicle following control. The report processing unit F9 may transmit the traffic signal response report in response to detecting a change in the lighting state of traffic signal 9 as a trigger in a state where the remaining distance to the traffic signal/intersection is equal to or less than a predetermined value. As a report event, which is an event (also referred to as trigger) for transmitting the traffic signal response report, a driver operation, stop/start of a preceding vehicle, a change in lighting state, or the like can be adopted.

The report processing unit F9 may transmit the traffic signal response report on condition that the green arrow light is in turned-on state or multiple light elements are in turned-on states. The report processing unit F9 may transmit the traffic signal response report only when the vehicle passes the traffic signal with arrow light 9A. The report processing unit F9 may transmit a series of behavior data of host vehicle related to passing of one traffic signal 9 together as one data set, or may transmit the behavior data by dividing the data into multiple data segments. The report processing unit F9 may transmit, as the traffic signal response report, a data set indicating the lighting state of traffic signal 9 when the preceding vehicle or the host vehicle starts movement. The report processing unit F9 may transmit, as the traffic signal response report, a data set indicating the lighting state of traffic signal 9 when the preceding vehicle or the host vehicle stops movement.

The report processing unit F9 may further transmit a data set indicating the lighting state of traffic signal 9 for the adjacent lane, the adjacent lane ID, and the behavior of another vehicle traveling in the adjacent lane, to the map generation server 3. According to the configuration in which not only the information on the host vehicle lane but also the information on the adjacent lane is transmitted, it is possible to more efficiently collect the data indicating the appropriate vehicle behavior corresponding to the lighting state of traffic signal 9 in the map generation server 3.

The report processing unit F9 uploads probe data for updating the road structure and the planimetric feature information in the map data periodically or in response to an instruction from the map generation server 3, in addition to the data indicating the behavior of host vehicle/other vehicles according to the lighting state of the traffic signal 9. The probe data may include position information of the vehicle, position information of the observed planimetric feature, and the like. Note that the traffic signal response report can also be interpreted as an example of probe data. The probe data and the traffic signal response report may be integrated with one another. A data set including information indicating the lighting state of traffic signal, the vehicle behavior corresponding to the lighting state of traffic signal, and information indicating the traveling position of host vehicle in the road width direction may correspond to the traffic signal response report. For example, probe data transmitted when the vehicle is positioned within a predetermined distance from the traffic signal may correspond to the traffic signal response report.

### Configuration of Map Generation Server 3

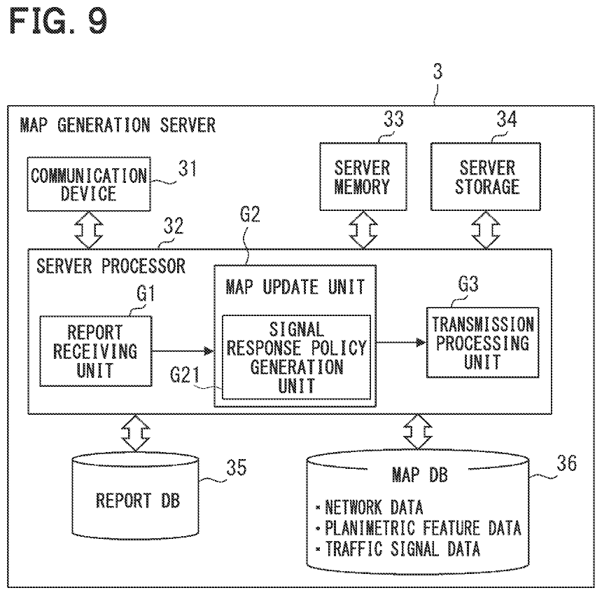

The following will describe a configuration of the map generation server 3. As illustrated in FIG. 9, the map generation server 3 includes a communication device 31, a server processor 32, a server memory 33, a server storage 34, a report DB 35, and a map DB 36. Herein, DB is an abbreviation for database.

The communication device 31 is a communication module for performing data communication with each vehicle via a wide area communication network, such as the Internet. The communication device 31 is configured to be able to communicate with a communication facility constituting a wide area communication network using, for example, an optical fiber. The map generation server 3 can perform data communication with the vehicles connected to the wide area communication network. The communication device 31 outputs data transmitted from the vehicles to the server processor 32, and transmits data input from the server processor 32 to the vehicle designated by the server processor 32. The expression “vehicle” as a communication partner of the map generation server 3 can be read as the vehicle control system 1, more specifically, the drive assist ECU 20 mounted on the vehicle.

The server processor 32 is configured to execute various processes based on signals/data input from the communication device 31. The server processor 32 is connected to the communication device 31, the server memory 33, the server storage 34, the report DB 35, and the map DB 36 so as to be able to communicate with each other. The server processor 32 is provided by an arithmetic core that executes various types of arithmetic processing, and is implemented by using, for example, a CPU, a GPU, or the like. The server memory 33 is a volatile memory, such as a RAM. The server memory 33 temporarily stores calculated by the server processor 32. The server storage 34 is a rewritable non-volatile memory. The server storage 34 stores a predetermined map generation program. When the server processor 32 executes the map generation program, various functional units described later are implemented. Execution of the map generation program by the server processor 32 corresponds to execution of a map generation method that corresponds to the map generation program.

The report DB 35 is a database for temporarily storing the traffic signal response report transmitted from the vehicle. The report DB 35 may store probe data. The report DB 35 is implemented by using a rewritable non-volatile storage medium. The report DB 35 is configured to allow the server processor 32 to write, read, and delete data.

The map DB 36 is a database in which the above-described map data is stored. The map DB 36 is implemented by using a rewritable non-volatile storage medium. The map DB 36 is configured to allow the server processor 32 to write, read, and delete data.

The map generation server 3 includes, as functional units, a report receiving unit G1, a map update unit G2, and a transmission processing unit G3. The map update unit G2 includes a traffic signal response policy generation unit G21 as a sub-function. The traffic signal response policy generation unit G21 may be provided independently of the map update unit G2. The map update unit G2 as a configuration independent of the traffic signal response policy generation unit G21 is an optional element and may be omitted. The map generation server 3 corresponds to a vehicle data generation server.

The report receiving unit G1 acquires the traffic signal response report and the probe data uploaded from the vehicle via the communication device 31. The report receiving unit G1 stores the traffic signal response report and the like acquired from the communication device 31 in the report DB 35. The report receiving unit G1 may store the received traffic signal response report separately for each corresponding traffic signal 9 or for each lane in which the report source has traveled. The data stored in the report DB 35 can be referred to by the map update unit G2, the traffic signal response policy generation unit G21, and the like. The report receiving unit G1 corresponds to a report acquiring unit. The map update unit G2 performs a process of updating map data based on probe data transmitted from multiple vehicles. For example, for the same planimetric feature, the position of planimetric feature is determined by integrating the observation coordinates reported from multiple vehicles, thereby updating the map data. The map update unit G2 updates the map data, for example, at a predetermined cycle.

The traffic signal response policy generation unit G21 is configured to generate a passable pattern for each traffic signal 9 and each lane based on traffic signal response reports provided from multiple vehicles. The process of generating the passable pattern for each lane is also referred to as a traffic signal response policy generation process. The traffic signal response policy generation process may be executed for the traffic signal 9 to which the green arrow light is provided. Details of the traffic signal response policy generation process will be described later.

The transmission processing unit G3 is configured to transmit, to the map distribution server 4, the map data including the traffic signal data. The transmission of map data to the map distribution server 4 may be performed in response to a request from the map distribution server 4 or may be performed periodically. The transmission processing unit G3 may transmit partial or entire map data to the map distribution server 4 in response to occurrence of a predetermined transmission event. For example, the transmission processing unit G3 may transmit, to the map distribution server 4, a data patch in which the recorded content is changed (that is, the map is updated) based on the probe data. As another aspect, the transmission processing unit G3 may be configured to distribute the map data in response to a request from the vehicle. The map distribution server 4, the drive assist ECU 20, and the like correspond to external devices when viewed from the map generation server 3.

The map distribution server 4 is a server that distributes the map data provided from the map generation server 3 to a vehicle, which corresponds to a request source, in units of data patches in response to a request from the vehicle. For example, the map acquiring unit F2 of the vehicle requests the map distribution server 4 for distribution of map data related to the current position and an area through which the vehicle is scheduled to pass within a predetermined time. The map distribution server 4 distributes corresponding map data patch in response to a request from the vehicle. The map distribution server 4 may be configured to distribute only partial items included in the map data in response to a request from the vehicle. For example, in response to a request from a vehicle, the map distribution server 4 may distribute only traffic signal data to the vehicle in association with corresponding link/node data, as map data related to passing through an intersection.

### Response Pattern Generation

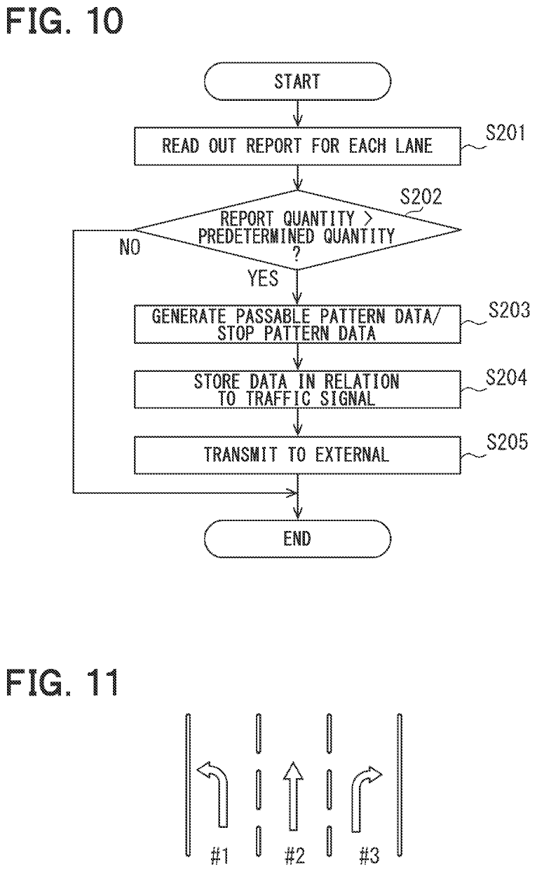

The traffic signal response policy generation process performed by the traffic signal response policy generation unit G21 will be described with reference to a flowchart illustrated in FIG. 10. For example, the flowchart illustrated in FIG. 10 is executed at a predetermined generation cycle. The generation cycle is properly set as one day, one week, or one month. As an example, the traffic signal response policy generation process may include S201 to S205 as shown in FIG. 10. The number of steps and the processing procedure included in the traffic signal response policy generation process can be appropriately changed. The traffic signal response policy generation process can be performed for each traffic signal 9. For convenience, the traffic signal 9 to be processed is also referred to as a target traffic signal. The traffic signal response policy generation process may be executed only for the traffic signal 9 including the green arrow light.

In S201, the process reads out the traffic signal response report for the target traffic signal from the report DB 35. In S201, the process may collect traffic signal response reports for the target traffic signal from multiple vehicles. The process of receiving the traffic signal response report transmitted from each vehicle may be performed in successive manner.

In S202, the process determines whether a quantity of reports on the target traffic signal is equal to or more than a predetermined quantity. The predetermined quantity may be set as 10 or 20. In S202, the process may determine whether the predetermined quantity or more of traffic signal response reports are collected for each lane.

When the quantity of reports on the target traffic signal is equal to or more than the predetermined quantity, the process proceeds to S203. For a lane in which the quantity of received traffic signal response reports is less than the predetermined quantity, the subsequent process is omitted. That is, the determination of passable pattern is postponed for the lane in which the quantity of received reports is less than the predetermined quantity.

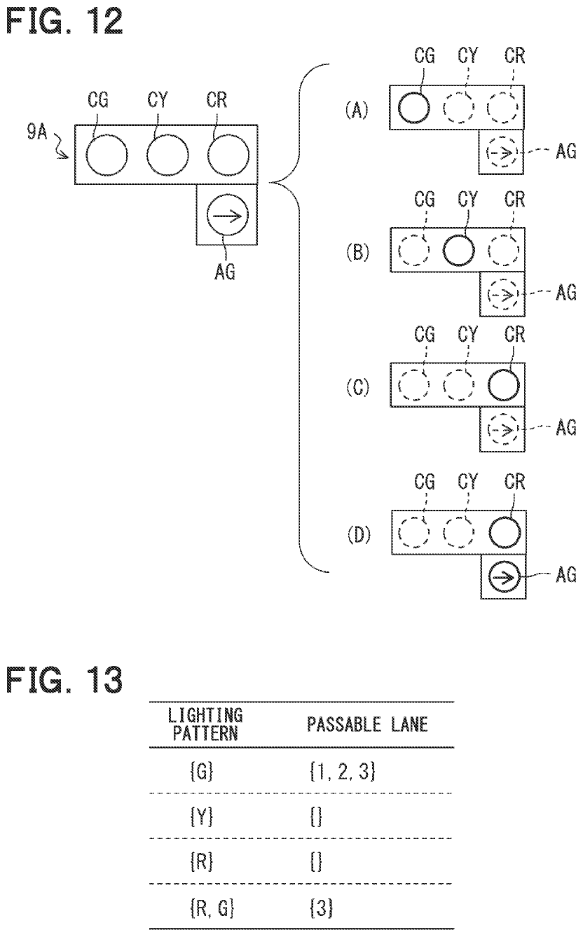

In S203, the process generates data indicating passable pattern for each lane, that is, passable pattern data based on the collected traffic signal response reports for each lane. FIG. 13 shows an example of passable pattern data when the traffic signal 9 shown in FIG. 12 is provided on a road having the lane structure shown in FIG. 11. FIG. 13 is an example of passable pattern data in a case where the traffic signal 9 with the green arrow light AG for right turn shown in FIG. 12 is provided on the road having the lane configuration shown in FIG. 11. The road shown in FIG. 11 has three lanes on each side, in which the first lane is set as a left-turn only lane, the second lane is set as a straight-ahead lane, and the third lane is set as a right-turn only lane.

In FIG. 12, CG indicates a green circular light element which changes to green color when activated, and CY indicates a yellow circular light element which changes to yellow color when activated. CR indicates a red circular light element which changes to red color when activated. In FIG. 12, a rightward green arrow light element AG is shown as an example. The rightward green arrow light element AG is a green arrow light for right turn. When the rightward green arrow light element AG is activated, that is, turned on, the rightward green arrow light element AG indicates that a right turn is possible.

As shown in (A) to (D) of FIG. 12, the traffic signal 9 can cyclically take, as a lighting pattern, a state in which only the green circular light element is turned on, a state in which only the yellow circular light element is turned on, a state in which only the red circular light element is turned on, and a state in which the red circular light element and the green arrow light element are turned on. For such a lighting pattern of the traffic signal 9, the traffic signal response policy generation unit G21 generates, for each lane, passable pattern data illustrated in FIG. 13 based on the reports from the vehicles.

In the lighting pattern shown in FIG. 13, {G} indicates a state where only the green circular light element CG is turned on, and {Y} indicates a state where only the yellow circular light element CY is turned on. The lighting pattern {R} indicates a state where only the red circular light element CR is turned on. The lighting pattern {R, G} indicates a state where the red circular light element CR and the green arrow light element AG are turned on together. In FIG. 13, G means green, Y means yellow, and R means red.

The passable lanes {1, 2, 3} shown in FIG. 13 indicate that the first, second, and third lanes are passable. The passable lane indicates that only the third lane is passable. In FIG. 13, { } (empty set) indicates that there is no passable lane, that is, passing are prohibited for vehicles in any lane. The passing propriety according to the lighting state for each lane is determined by the vehicle behavior for each lane associated with the lighting state.

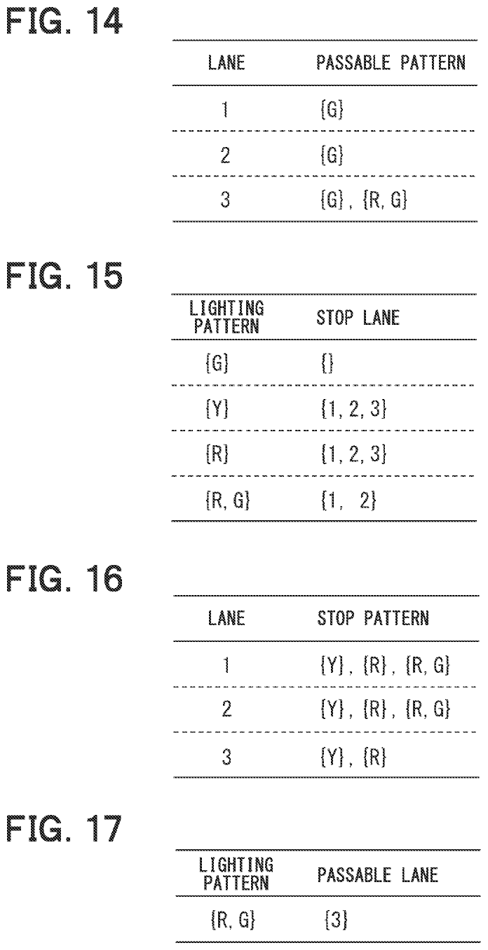

The configuration of passable pattern data is not limited to the example illustrated in FIG. 13. For example, as illustrated in FIG. 14, the data may be configured as data indicating a passable lighting state for each lane. FIG. 13 and FIG. 14 are substantially equivalent to each other except for the expression format.

When the generation of passable pattern data for the target traffic signal is completed (S203), the traffic signal response policy generation unit G21 stores the data set in the map DB 36 as a part of the traffic signal data of the map data (S204). In the map data, the passable pattern data for each traffic signal 9 is associated with the traffic signal 9 included in the map data using a traffic signal ID or the like. The corresponding traffic signal 9 is associated with network data such as node data and link data. That is, the passable pattern data is stored in association with the network data. In S205, the transmission processing unit G3 transmits the generated map data including the passable pattern data to an external device, such as the map distribution server 4. S205 can be executed at a proper timing.

The traffic signal response policy generation unit G21 of the present embodiment generates passable pattern data as traffic signal response policy data. The traffic signal response policy data is a data set indicating a response policy for each lane corresponding to the lighting state of traffic signal 9. The traffic signal response policy data is not limited to the passable pattern data. The traffic signal response policy generation unit G21 may generate stop pattern data as the traffic signal response policy data as illustrated in FIG. 15 and FIG. 16. The stop pattern data is a data set indicating a lighting pattern for each lane in which the vehicle should make a stop. The map distribution server 4 may distribute the stop pattern data instead of the passable pattern data as a part of the map data.

A combination of lighting colors, which is not defined as the passable pattern, corresponds to the stop pattern. That is, the stop pattern data corresponds to the reverse of passable pattern data. FIG. 15 shows a configuration of stop pattern data corresponding to FIG. 13, and shows lane numbers in which the vehicles should be stopped for each lighting pattern. FIG. 16 shows another expression format of the stop pattern data, and shows a combination of lighting colors for which the vehicle should stop for each lane. The stop pattern is a lighting pattern that prohibits entry into the intersection, and thus may be referred to as an entry prohibition pattern.

In the present disclosure, when the passable pattern data and the stop pattern data are not distinguished from one another, the passable pattern data and the stop pattern data may be collectively referred to as traffic signal response policy data. The traffic signal response policy data may also be referred to as lane-based response policy data. The traffic signal response policy data corresponds to vehicle data for assisting vehicle control execution, that is, vehicle control data. The description related to passable pattern data may be applicable to the stop pattern data as appropriate.

In the traffic signal response policy data, data on single color lighting pattern in which only green light element, only yellow light element, or only red light element is turned on may be omitted. For example, the passable pattern data shown in FIG. 13 can be omitted to a data set including only data on a pattern in which red and green are simultaneously turned on, as shown in FIG. 17. The single color lighting pattern corresponds to a state in which there is only one activated light element. In the present disclosure, a pattern in which (i) a red circular light element or a yellow circular light element and (ii) at least one green arrow light element are activated is referred to as a mixed color lighting pattern.

The traffic signal response policy data may be configured to include only the mixed color lighting pattern, in other words, a lighting pattern related to the green arrow light element. This is because, for the single color lighting pattern, the drive assist ECU 20 usually follows the lighting color, and the necessity of distribution as map data is low. In the mixed color lighting pattern, when the vehicle is far from the traffic light and the direction of green arrow light element is unknown, the host vehicle is difficult to determine whether to make a stop. In view of such circumstances, a data set indicating passing propriety for each lane in the mixed color lighting pattern can be relatively useful in planning/execution of vehicle control. According to the configuration in which the traffic signal response policy generation unit G21 generates, as the traffic signal response policy data, the data set including only the data indicating the passing propriety for each lane with respect to the mixed color lighting pattern, it is possible to suppress the data size of distribution data.

The traffic signal response policy generation unit G21 may be configured to generate the traffic signal response policy data only for the traffic signal with arrow light element 9A. It is also possible to suppress the size of distribution data by a configuration in which the traffic signal response policy data is not generated for the standard traffic signal, which is the traffic signal 9 not including the arrow light element. According to the above-described system configuration, the drive assist ECU 20 can acquire the traffic signal response policy data for the traffic signal 9A with arrow light element. Thus, it is easy to determine whether the host vehicle can pass the intersection where the traffic signal 9A with arrow light element is provided.

There may be an area/intersection where a right turn is possible in the rightmost lane or a left turn is possible in the leftmost lane even when only the red light element is in activated state. There is an intersection to which a rule (hereinafter, an exceptional rule) different from the basic rule applied to the area is limitedly applied by a specific sign such as “NO TURN ON RED”. The traffic signal response policy generation unit G21 may generate a data set indicating passable/not-passable lane number for each lighting pattern as traffic signal response policy data for an intersection, to which the exception rule is applied using an arrow light element or a sign. According to the configuration in which the traffic signal response policy data is generated/distributed only to the traffic signal to which the exception rule is applied, it is possible to suppress the size of the map data to be distributed.

### Supplement of Traffic Signal Response Policy Data

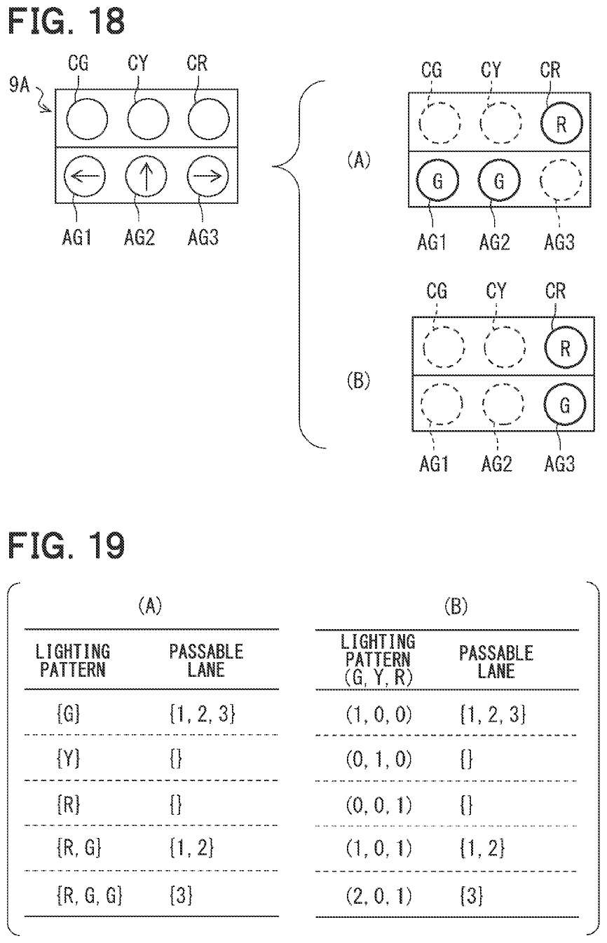

The quantity and lighting patterns of green arrow light element(s) included in the traffic signal 9 are various. For example, as illustrated in FIG. 18, there may be a traffic signal 9 to which a green arrow light element AG1 for left turn, a green arrow light element AG2 for straight travel, and a green arrow light element AG3 for right turn are provided, as the green arrow light elements AG. When such a traffic signal 9 can take a first pattern illustrated in (A) of FIG. 18 and a second pattern illustrated in (B) of FIG. 18 as the mixed color lighting pattern, the traffic signal response policy generation unit G21 can generate, for each lane, passable pattern data illustrated in FIG. 19 based on reports from the vehicles. The first pattern is a pattern in which the red circular light element CR, the left-turn green arrow light element AG1, and the straight-travel green arrow light element AG2 are simultaneously turned on. The second pattern is a pattern in which the red circular light element CR and the right-turn green arrow light element AG3 are turned on.

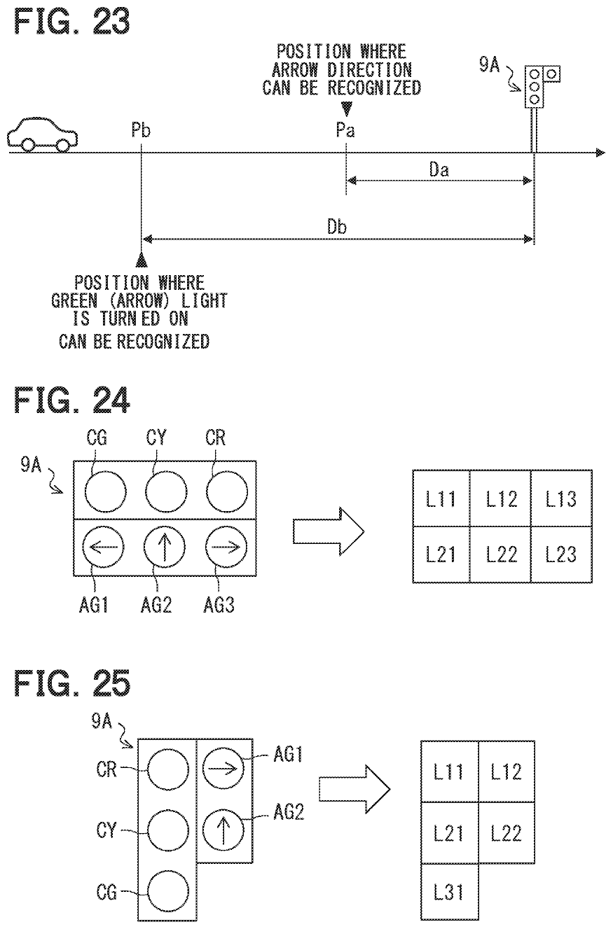

Since the first pattern and the second pattern differ in the quantity of green arrow light elements, passable lanes can be distinguished without including more detailed information, such as which light element of the traffic signal 9 is in turned-on state. Therefore, even with a simple data set that does not include the location information of activated light element with respect to the housing of traffic signal 9 that can take such a lighting pattern, the vehicle can appropriately determine whether to pass the traffic signal according to the lighting state. Note that (A) and (B) of FIG. 19 have substantially same lighting pattern expressed in different formats (A) and (B) of FIG. 19 both show passable lane number using a combination of quantity of each activated color. The traffic signal response policy data illustrated in FIG. 19 may also be expressed in the formats of FIG. 23, FIG. 15, FIG. 16, FIG. 17, or the like.

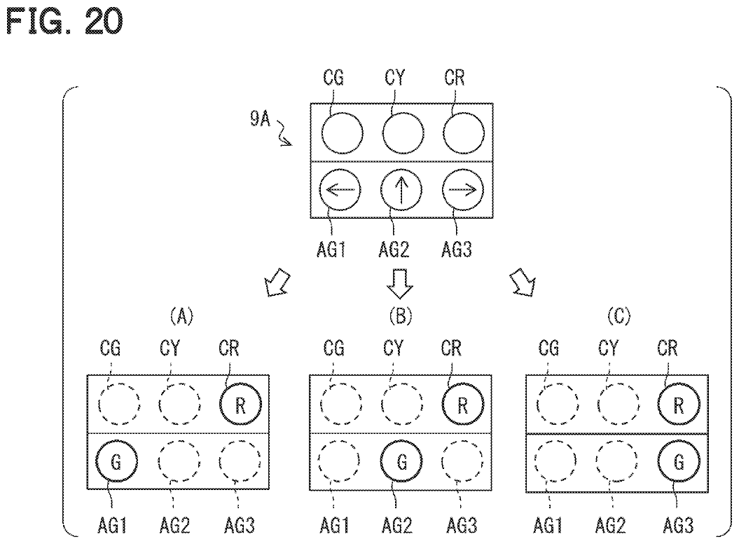

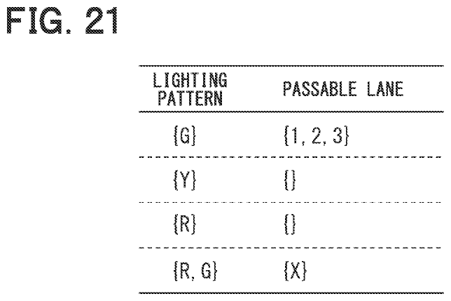

As another lighting pattern of traffic signal 9 including multiple green arrow light elements, there is a pattern in which multiple green arrow light elements AG are activated one by one together with the red circular light element as illustrated in FIG. 20. That is, there is a pattern in which the red circular light element CR and the left-turn green arrow light element AG1 are turned on, a pattern in which the red circular light element CR and the straight-ahead green arrow light element AG2 are turned on, and a pattern in which the red circular light element CR and the right-turn green arrow light element AG3 are turned on. In such a case, it is not possible to distinguish whether each lane is passable only with information indicating activated red light element and activated green light element. This is because, although the combination of quantities of lighting colors is the same, the passable lane number differs depending on the location of activated green light element. In a case where the passing propriety for each lane cannot be distinguished only by the combination of lighting colors, as illustrated in FIG. 21, a predetermined special value (“X” in FIG. 21) may be inserted into the data field indicating the passable lane number corresponding to the lighting pattern that cannot be distinguished. The special value is a value (code) indicating that a passable lane is unknown. The special value indicates that the host vehicle lane may be passable. When the lighting pattern recognized by the front camera 11 indicates the lighting pattern corresponding to the special value, the drive assist ECU 20 may forbid the automatic deceleration control or the like, and request the driver to perform the driving operation after properly confirming the direction of arrow light element.

### Example of Vehicle Control Using Passable Pattern Data

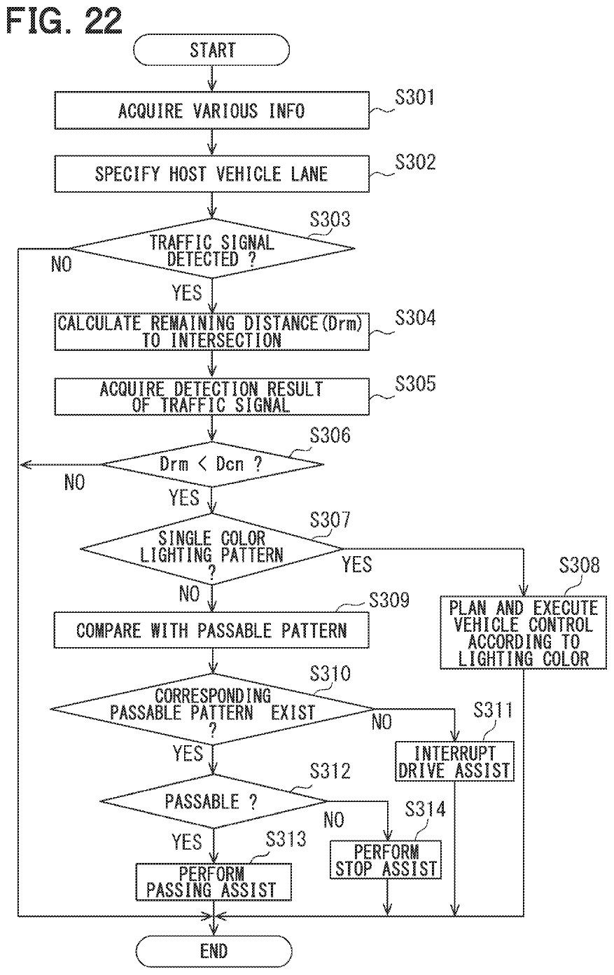

The following will describe an example of vehicle control using the passable pattern data, in other words, an operation example of the drive assist ECU 20 with reference to a flowchart illustrated in FIG. 22. In the present disclosure, the process corresponding to the flowchart illustrated in FIG. 22 is also referred to as a traffic signal passing assistance process. The traffic signal passing assistance process includes S301 to S314 as an example. The traffic signal passing assistance process is executed at a predetermined cycle, such as 200 milliseconds while the traveling power supply is in turned-on state. The traffic signal passing assistance process is executed on condition that the driving assist function to be executed by the drive assist ECU 20 is activated by the driver. In the present embodiment, as an example, the driving assistance performed by the drive assist ECU 20 includes control for automatically adjusting the travel speed according to the inter-vehicle distance to the preceding vehicle. However, the present disclosure is not limited to this configuration. The driving assist may be a proposal of driving operation according to the traveling environment without performing the traveling control.

The traffic signal passing assistance process illustrated in FIG. 22 can be performed in parallel with or in combination with the above-described various processes, such as the traffic signal response report process and the process related to the map download. Here, a case where the passable pattern data is distributed to the vehicle will be described. The traffic signal passing assistance process may also be applied to a case where the stop pattern data is distributed.

In S301, similarly to S101, the environment recognizing unit F6 acquires information indicating the travel environment based on signals from various devices. In S302, the localization unit F5 specifies the vehicle position coordinates and the vehicle lane ID based on the input signals from the front camera 11. S302 may be integrated with S301. In S303, similarly to S103, the environment recognizing unit F6 determines whether the traffic signal 9 for the host vehicle is detected by the front camera 11. When the traffic signal 9 for the host vehicle is not detected, the process determines NO in S303, and the current flow is ended. When the traffic signal 9 for the host vehicle is detected, the process proceeds to S304.

In S304, the environment recognizing unit F6 acquires the remaining distance (Drm) to the intersection corresponding to the traffic signal 9 detected in S303. The remaining distance to the intersection may be acquired from the front camera 11 as an image recognition result, or may be specified by comparing the position information of the intersection indicated in the map data with the host vehicle position information. The remaining distance to the intersection can be, for example, a remaining distance to a stop line of the intersection.

In S305, the camera output acquiring unit F3 acquires the combination of colors of the activated light elements as the recognition result of the lighting state of traffic signal 9 for the host vehicle. For example, when there is only one activated light element, the color of activated light element is acquired. When there are multiple activated light elements, the camera output acquiring unit acquires a combination of colors and the quantity of activated light elements for each color. When the red circular light element, the green arrow light element for left turn, and the green arrow light element for straight travel are turned on as illustrated in (A) of FIG. 18, the environment recognizing unit F6 acquires that the combination of lighting colors is one red light element and two green light elements. In the present embodiment, the shape of activated light element may be performed as necessary. The shape of activated light element, such as the direction of arrow may be specified. However, when the shape of activated light element is unknown, the subsequent process can be executed assuming that the shape is unknown.

In S306, the environment recognizing unit F6 determines whether the remaining distance (Drm) to the intersection is less than a predetermined control continuation determination distance (Dcn). The control continuation determination distance may be set to 50 meters or 75 meters. The control continuation determination distance may be changed according to the scale of road, the speed limit of road, the current vehicle speed, and the like. The control continuation determination distance can be set to be increase as an increase of the vehicle speed. For example, the control continuation determination distance is set to a value at which the vehicle can stop at a predetermined deceleration before reaching the intersection. More specifically, when the current velocity is Vo and the deceleration is a, the remaining distance Drm can be a value obtained by adding a predetermined tolerance ε to Vo\hat{ }2/(2a). The tolerance ε can be set to, for example, 10 meters, 15 meters, or 20 meters. The tolerance is set such that a time required for the driver to take over the driving operation related to acceleration or deceleration is secured.

When the remaining distance to the intersection is less than the control continuation determination distance, that is, when the relationship of Drm<Dcn is satisfied, the process proceeds to S307, and subsequent process is executed. When the remaining distance to the intersection is equal to or greater than the control continuation determination distance, that is, when the relationship of Drm≥ Dcn is established, the current flow is ended. In this case, the process shown in FIG. 22 is executed again from S301 after elapse of a predetermined time.

In S307, the process determines whether the lighting state of traffic signal 9 corresponds to the single color lighting pattern. S307 can be generally understood as a process of determining whether only one activated light element is recognized in the traffic signal 9. A pattern in which a red or yellow circular light element is not turned on and multiple green arrow light elements are turned on, that is, a pattern in which only multiple green arrow light elements are simultaneously turned on can also be included in the single color lighting pattern.

When the lighting state of traffic signal 9 is not the mixed color, the process proceeds to S308. In S308, the control planning unit F7 plans the vehicle control according to the turned-on color, and the control execution unit F8 executes the vehicle control according to the control plan. For example, when the activated color is red, the drive assist ECU 20 starts the deceleration control for stopping the vehicle. When the activated color is green, the preceding vehicle following control is continued. When the preceding vehicle following control is set to OFF state by the driver's operation, only information presentation, such as entry possible image Im2 can be displayed. When a right or left turn is planned, deceleration control for stopping at the temporary stop line is started.

When the lighting color is yellow, deceleration control for stopping the vehicle before the intersection is executed in principle. At a time when the lighting color of yellow is recognized, if the vehicle is already located within the intersection, travel control for passing through the intersection is executed. The travel control for passing through the intersection is also executed when it is determined that the vehicle cannot stop before the intersection at a reasonable deceleration, for example, when the remaining distance is less than the braking distance at the time of recognizing the lighting color of yellow. Since this flow is repeatedly executed at predetermined intervals, the recognition result of traffic signal lighting state and the control plan according to the recognition result can also be dynamically updated at proper timing.

The notification processing unit Fa displays the determination result image Imk on the display 151 corresponding to the determination result. When the system is operating normally, notification using a sound may annoy the driver. Therefore, notification using a sound, such as a notification sound may be not output unless a specific error state occurs. The output condition of notification sound and the voice message may be configured to be settable by the driver on a predetermined setting screen.

When the recognized lighting state of traffic signal 9 corresponds to the mixed color lighting pattern, the environment recognizing unit F6 compares the recognized combination of lighting colors with the passable pattern of host vehicle lane in S309. As a result of the comparison, when the combination of recognized lighting colors matches the passable pattern of host vehicle lane, the environment recognizing unit F6 determines that the intersection is passable, and outputs a passing allowed signal, which indicates that the intersection is passable, to the control planning unit F7. The passing allowed signal may be a message signal indicating that the vehicle can pass through (enter) the intersection. The control planning unit F7 generates a control plan for passing through the intersection in response to input of the passing allowed signal from the environment recognizing unit F6. Then, the control execution unit F8 continues the control assist according to the planned route based on the control plan generated by the control planning unit F7 (S313).

For example, when the environment recognizing unit F6 determines that the vehicle can pass through the intersection and the vehicle is scheduled to travel straight at the intersection, the control execution unit F8 continues the preceding vehicle following control. In response to determining that the vehicle can pass through the intersection and the vehicle is scheduled to travel straight at the intersection, the notification processing unit Fa displays the entry possible image Im2 on the display 151 corresponding to the vehicle control in S313. At this time, the process does not output a special voice message or notification sound.

Even when the environment recognizing unit F6 determines that the traffic signal lighting state is a pattern in which the host vehicle can pass, if a right or left turn at the intersection is planned, the control planning unit F7 temporarily stops the preceding vehicle following control and starts deceleration control for stopping at the temporary stop line. At this time, the notification processing unit Fa performs sound notification for prompting confirmation of traffic situation toward the right turn destination/left turn destination. The drive assist ECU 20 performs the driving assist related to the right or left turn. By stopping the preceding vehicle following control, it is possible to reduce the possibility that acceleration/start/entry into the intersection is automatically executed following the preceding vehicle.

When the combination of recognized lighting colors does not correspond to the passable pattern of host vehicle lane, the environment recognizing unit F6 determines that the host vehicle cannot enter the intersection, and outputs a predetermined passing prohibited signal to the control planning unit F7. The passing prohibited signal may be a message indicating that entry to the intersection is prohibited. The control planning unit F7 generates a deceleration control plan for stopping the vehicle in response that the passing prohibited signal being input from the environment recognizing unit F6. Then, the control execution unit F8 starts the deceleration control for stopping the vehicle (S314).

When the passing prohibited signal is output, the control planning unit F7 can temporarily stop the preceding vehicle following control at a predetermined timing. The preceding vehicle following control may be stopped at a timing at which automatic deceleration for stopping is started, or a time difference to the deceleration for stopping may be provided. The preceding vehicle following control may be continued until the host vehicle completely stops, the distance to the traffic signal becomes equal to or less than a predetermined value, or the host vehicle reaches a temporary stop line. The notification processing unit Fa displays the entry prohibition image Im1 on the display 151 corresponding to the vehicle control in S312. Also in this case, since the system itself is operating normally, the process does not output special sound message or notification sound. Instead of starting the automatic deceleration control, the control execution unit F8 may execute notification process for prompting the driver to execute the deceleration operation.

When the combination of recognized lighting colors does not correspond to the passable pattern of any lane defined in the passable pattern data (S310: NO), the environment recognizing unit F6 determines that it is impossible to determine passing propriety in the intersection. In this case, the environment recognizing unit F6 outputs, to the control planning unit F7, a determination failure signal. The determination failure signal may be a message indicating that it is impossible to determine whether the host vehicle can enter the intersection at the current time.

The control planning unit F7 interrupts the driving assistance for passing through the forward intersection in response to input of the determination failure signal from the environment recognizing unit F6 (S311). For example, the control planning unit F7 ends control for automatically adjusting the travel speed, such as preceding vehicle following control or deceleration for stopping. In this case, the notification processing unit Fa outputs a sound message indicating that the assistance related to speed control ends via the speaker 152, and displays a text message indicating the same content on the display 151. The message indicating that the assistance related to the speed control is ended may be, for example, “The control is interrupted because the lighting state of traffic signal cannot be normally recognized”. A warning sound may be output instead of or in parallel with the sound message. Output of this notification corresponds to a control stop notification process.

Although a case where the vehicle passes the intersection is described as an example, the present disclosure can also be applied to a case where the vehicle stops before an intersection. When the traffic signal 9 is changed from red to green, the passable mark Imk2 or the like may be displayed together with the notification sound. When the recognized lighting state corresponds to the single color lighting pattern, the environment recognizing unit F6 outputs the passing allowed signal or the passing prohibited signal corresponding to the lighting state of colors.

In the above description, the operation of drive assist ECU 20 has been described on the assumption that the host vehicle lane can be specified. In some cases, the drive assist ECU 20 may fail to specify the host vehicle lane ID or the like due to occurrence of error. The environment recognizing unit F6 may output the determination failure signal when a state in which the drive assist ECU fails to specify the host vehicle lane ID continues for a predetermined time. The determination failure signal may include information indicating the reason of failure.

When the determination failure signal is output in response that the host vehicle lane ID is unknown, the notification processing unit Fa performs the operation request process, and then the control planning unit F7 ends the automatic control related to speed control and lane keeping. The operation request process outputs a message requesting a proper driving operation corresponding to the lighting state of traffic signal 9 by outputting a sound and an image. When the control is interrupted due to the failing to specify the host vehicle lane ID, the notification processing unit Fa outputs a sound message, such as “The control is interrupted because the traveling lane is unclear” via the speaker 152 as the operation request process. A similar text message may be displayed on the display 151. The notification processing unit Fa performs notification using sound only when an error occurs in the system, and thus it is possible to transmit necessary information to the driver while reducing the possibility of annoying the driver.

A failure to acquire the map data may occur as an error in the drive assist ECU 20. The environment recognizing unit F6 may output the determination failure signal when forward map data of the host vehicle cannot be acquired. The control planning unit F7 may switch the driving authority to the driver and ends the automatic control related to the speed control and lane keep control when the determination failure signal is input in response to failing to acquire the map data.

As described above with reference to FIG. 21, in a lighting pattern including activated green arrow light element, when the lighting pattern corresponds to a type in which passing propriety for each lane cannot be determined only by the combination of lighting colors, the environment recognizing unit F6 may determine failure of passing propriety determination and output the determination failure signal. The notification processing unit Fa executes the operation request process similar to the above-described configuration, and the control planning unit F7 stops the automatic control related to speed control (in other words, acceleration and deceleration). Stopping the automatic control related to acceleration and deceleration corresponds to stopping the automatic adjustment of vehicle speed, in other words, stopping the preceding vehicle following control.

In the present embodiment, the operation request process is executed in response to output of the determination failure signal, which is output when the remaining distance Drm to the intersection becomes less than the control continuation determination distance Dcn. The control continuation determination distance Dcn is set to be longer than an emergency braking distance Dstp. The emergency braking distance Dstp in the present disclosure is a distance required for stopping the vehicle when the vehicle decelerates at a basic deceleration α. The basic deceleration α is a predetermined acceleration within a range that does not give discomfort to the driver. The basic deceleration α can be set to 1.0 m/s\hat{ }2, 1.25 m/s\hat{ }2, 1.5 m/s\hat{ }2, or the like. When the applied deceleration is set to α, the emergency braking distance Dstp=Vo\hat{ }2/(2α). The deceleration start point, which is a point corresponding to the timing at which the start of deceleration is necessary to be made, is a point before the intersection by at least the emergency braking distance Dstp. The above configuration corresponds to a configuration in which the end of automatic control and the takeover request of driving operation due to recognition error of the traffic signal 9 are performed a predetermined time before the timing at which the deceleration start is required. According to this configuration, the driver can recognize the lighting state of traffic signal, then determine and operate the vehicle control at an early stage with sufficient time.

### Effects of Above Configuration

Each light element included in the traffic signal 9 is smaller than an object such as a preceding vehicle. Therefore, as illustrated in FIG. 23, the camera ECU 112 cannot determine the direction of green arrow light until the vehicle approaches the traffic signal 9 to a sufficiently close distance. In particular, in a bad environment, such as rainfall, the shape of light element is blurred due to raindrops or the like, and thus it is difficult to recognize the direction of arrow light element. Assuming that a distance at which the direction/shape of the green arrow light element can be recognized is a shape recognizable distance Da, the shape recognizable distance Da may be longer than the emergency braking distance Dstp depending on the environment. That is, the direction of green arrow light element may not be specified until the vehicle passes through the point at which braking should be started.

As a first comparative configuration for performing an intersection passing assistance using the recognition result of traffic signal, braking may be started after the direction of green arrow light element is recognized. In the first comparative configuration, since the start of deceleration is delayed, a relatively large deceleration may be applied to stop the vehicle before the intersection. In the first comparative configuration, the driver may feel uncomfortable due to the action of relatively large deceleration.

As a second comparative configuration, which is another comparative configuration, activated a green arrow light element may be ignored and braking for stopping the vehicle may be started in response to recognizing the activated red light element. In the second comparative configuration, deceleration may be performed even when deceleration is not originally necessary due to the activated green arrow light. When the host vehicle is scheduled to travel straight at the intersection and the green arrow light element for straight traveling is in turned-on state together with the turned-on red light element of the traffic signal, the deceleration control for stopping the vehicle may be carried out before the intersection in the second comparative configuration.

As shown in FIG. 23, even when it is difficult to specify the shape of activated light element, it is possible to recognize that the green light element is turned on from a relatively long distance. Assuming that a distance at which it is possible to recognize that the green arrow light element is in activated state corresponds to a lighting state recognizable distance Db, the lighting state recognizable distance Db is usually longer than the shape recognizable distance Da. In FIG. 23, Pb indicates a point where the lighting state of green light element provided by the green arrow light element can be recognized by image recognition. In FIG. 23, Pa indicates a point where the direction of activated green arrow light element can be recognized by image recognition.

As described above, the present disclosure has been made by focusing on the fact that it is possible to recognize that the green light element is in turned-on state from a relatively long distance, although whether the green arrow light element is turned on and the direction of the turned-on green arrow light cannot be determined. The server of the map cooperation system Sys distributes a data set, which indicates a combination of passing allowed/passing prohibited lighting color for each lane, to the vehicle as traffic signal response policy data. According to this configuration, the drive assist ECU 20 can determine whether the vehicle can pass the traffic signal 9 even when the shape of activated light element cannot be identified when passing of the traffic signal 9 can be determined only based on the combination of lighting colors. Regarding the intersection/traffic signal 9 that requires stop for each lane based on the combination of lighting colors, the drive assist ECU 20 can determine whether to stop the vehicle before the direction of arrow light element becomes recognizable (that is, in early stage). Therefore, it is possible to gradually decelerate the vehicle, and it is also possible to reduce a possibility of performing unnecessary deceleration. As illustrated in FIG. 12 and FIG. 18, the present disclosure is suitable for the traffic signal 9/intersection where passing propriety for each lane is uniquely determined according to the quantity of activated green arrow light elements.

The map generation server 3 generates the traffic signal response policy data based on the combination of lighting colors observed by multiple vehicles. In the observation data reported by multiple vehicles, the shape of activated light element may be arbitrary, and is not essential. In addition, it is not so difficult to observe the lighting color, observation of the lighting can be carried out by commercially available vehicle. Therefore, according to the above configuration, it is possible to generate the traffic signal response policy data based on a report from a commercially available general vehicle without using a probe car equipped with a high-performance sensor (that is, a special purpose car). According to the configuration of the present disclosure, it is possible to generate and update control assist data related to a traffic signal at a lower cost than the lighting pattern information disclosed in JP 2021-2275 A.

In a bad environment for the camera, such as rainy weather, it may be difficult to identify the shape of activated light element of the traffic signal 9. According to the configuration of the present disclosure, since it is possible to determine whether passing at the intersection is possible even in such a bad environment, the configuration of present disclosure can reduce the possibility of unnecessary deceleration or interruption of assistance control due to erroneous recognition/recognition failure of the lighting state. In other words, the ability to continue driving assistance control can be improved. In the server, storing the shape of activated light element into a database is an optional requirement, and thus the processing load can be reduced. According to the present disclosure, an effect of suppressing the size of distribution data can also be expected.

The drive assist ECU 20 notifies the driver of the recognition/determination result of system by an image during the normal operation state of system. According to this configuration, since the driver can understand the operation state (recognition state) of the system, a sense of security can be enhanced. In addition, even in a case where it is not possible to determine the passing propriety according to the lighting pattern of traffic signal 9, the presence of at least the traffic signal 9 is notified to the driver, thereby entrusting a driving safety to the driver. Since the notification is performed in a state where the remaining distance Drm to the intersection is longer than the emergency braking distance Dstp, the driver can determine the lighting state and perform the corresponding driving operation with sufficient time in an early stage.

The passing propriety for each lane according to the lighting state may also differ depending on a sign added to the traffic signal 9. For example, in the United States, when a red light is turned on, a right-turn lane at the right end is passable (right-turn is possible) in principle, but there are intersections where right-turn is prohibited even when the red light is in turned-on state defined by an auxiliary sign. The configuration disclosed in JP 2021-2275 A cannot cope with such an exceptional pattern. In the configuration disclosed in JP 2021-2275 A, even when the lighting state of traffic signal 9 can be recognized, it cannot be determined whether the vehicle can actually pass through the intersection. Since the traffic signal response policy data generated in the present disclosure is obtained by statistically processing the actual behaviors of vehicles according to the lighting state of the traffic signal 9, the traffic signal response policy data reflects the exceptional rule defined by the by the auxiliary sign. Therefore, even for an intersection at which an exceptional rule is applied by an auxiliary sign or the like, it is possible to accurately determine passing propriety corresponding to the lighting state of traffic signal.

Although the embodiments of the present disclosure have been described above, the present disclosure is not limited to the above-described embodiments, and various supplementary matters and modifications described below are also included in the technical scope of the present disclosure. Furthermore, various modifications other than the following can be made without departing from the scope of the present disclosure. For example, various supplements, modifications, and the like described below can be appropriately combined and implemented within a range in which no technical contradiction occurs. Components having the same or equivalent functions as those of the components described above are denoted by the same reference symbols, and description thereof may be omitted. When only a part of the configuration is mentioned, the description in the above embodiment can be applied to the remaining parts.

### Supplement 1

The control using the passable pattern data/stop pattern data by the drive assist ECU 20 may be applied only while the direction of green arrow light cannot be specified. When the direction/shape of green arrow light is obtained, the passing propriety determination based on the passable pattern data/stop pattern data may be omitted, and a control plan according to the actual direction of green arrow light may be generated and executed. The control using the passable pattern data/stop pattern data may be adopted as a provisional control policy until the direction of green arrow light can be specified.

### Supplement 2

In the above-described configuration, as the traffic signal response report, the drive assist ECU 20 transmits the data set including the host vehicle lane ID as the information indicating the traveling position in the road width direction. The configuration of the traffic signal response report is not limited thereto. The data uploaded as the traffic signal response report may not necessarily include the lane number. The traffic signal response report may include information indicating the traveling position of report source vehicle in the road width direction. The information indicating the lane in which the host vehicle (report source vehicle) is traveling corresponds to the information indicating traveling position in road width direction.

As the information indicating the traveling position in road width direction, for example, information indicating a relative position with respect to a periphery planimetric feature, more specifically, relative position information with respect to a predetermined feature such as a direction sign, a regulation arrow installed to a road surface as a road surface marking, paint as a flow guide zone, or a road edge can be adopted. The traffic signal response report may include, instead of or in parallel with the host vehicle lane ID, information on periphery planimetric features that can specify the travel lane of host vehicle. Accordingly, the drive assist ECU 20 may not necessarily identify the host vehicle lane ID when transmitting the traffic signal response report. That is, process in S102 is an option.

When the traffic signal response report does not include the host vehicle lane ID or the host vehicle lane ID is unknown, the map generation server 3 may specify the lane number on which the report source vehicle is traveling from the relative position information of the periphery planimetric feature included in the traffic signal response report. That is, the map generation server 3 may have the function of specifying the travel lane number. As a preparation process of S201, the map generation server 3 may perform a process of specifying the travel lane number of report source vehicle based on the relative position information of periphery planimetric feature that may be included in the traffic signal response direction. According to the configuration in which the map generation server 3 specifies the travel lane of the report source vehicle based on the relative position information of periphery planimetric feature, it is possible to cope with a situation when the drive assist ECU 20 fails to specify the host vehicle lane ID. The situation when the drive assist ECU 20 fails to specify the host vehicle lane ID is, for example, a situation in which the field of view of the front camera 11 is blocked by a periphery vehicle and the recognition result of road edge and boundary marking of the adjacent lane is insufficient.

### Supplement 3

In the above-described embodiment, the host vehicle lane ID is specified by analyzing the image generated by the front camera 11. The configuration for specifying the host vehicle lane ID is not limited thereto. The host vehicle lane ID may be specified by analyzing an image of a rear camera, which is mounted to a rear portion of the vehicle and captures a rearward view of the vehicle. The host vehicle lane ID may be specified by analyzing an image of a lateral side camera which is mounted to a lateral side portion of the vehicle and captures a lateral direction view of the vehicle. The host vehicle lane ID may be specified based on a detection result of LiDAR, millimeter wave radar, or the like.

The host vehicle lane ID may be specified based on a GNSS positioning result. When the GNSS positioning error is expected to be less than 10 cm, the processor 21 may specify the host vehicle lane ID based on the GNSS positioning result output from the locator 13. The GNSS positioning error can be expected to be less than 10 cm, for example, in a case where the vehicle-mounted GNSS receiver can receive a signal from a quasi-zenith satellite. When the travel lane ID can be received from a preceding vehicle by inter-vehicle communication, the travel lane ID may be adopted as the host vehicle lane ID.

The host vehicle lane ID may be specified based on information from a radio wave/optical beacon arranged to form a communication area for each lane. The radio wave/optical beacon corresponds to a roadside device disposed above a road. The host vehicle lane ID may be specified based on a signal from a magnetic marker embedded in a road surface. The magnetic marker is a communication device (wireless tag) embedded in the road surface. The magnetic marker transmits absolute position coordinates or a lane number voluntarily or in response to an inquiry from the vehicle. For example, a wireless ID tag of a non-feeding type can be adopted as the magnetic marker. The information indicating the traveling position of the host vehicle in the road width direction can be specified based on information input from various vehicle-mounted devices, such as a periphery monitoring sensor and a communication device.

### Supplement 4

In the above description, as the traffic signal passing assistance process, the drive assist ECU 20 compares the recognized lighting state with the passable pattern data when the remaining distance to the intersection is less than the predetermined value. The present disclosure is not limited thereto. When the traffic signal for the host vehicle is recognized by the front camera 11, the drive assist ECU 20 may periodically compare the recognized lighting state with the passable pattern data regardless of the remaining distance to the intersection. In a case where the remaining distance or the remaining time until the vehicle arrives at the intersection is equal to or greater than the predetermined threshold value, even though the environment recognizing unit F6 outputs the determination failure signal, the stop of control may be configured to be not performed. This is because there is a possibility that the lighting state of traffic signal 9 is switched to a pattern in which the passing propriety can be determined as the vehicle approaches the intersection. For example, before the remaining distance Drm to the intersection becomes less than the control continuation determination distance Dcn, the lighting state of traffic signal may switch from the mixed color lighting pattern, under which the passing propriety cannot be determined, to the single color lighting pattern. The control planning unit F7 may stop the speed control and perform the notification of control stop only when the environment recognizing unit F6 outputs the determination failure signal in a case where the remaining distance or the remaining time until reaching the intersection being less than the threshold value.

### Supplement 5

In the above description, as a control example, when the yellow light of traffic signal is turned on, the response is substantially the same as that when the red light is turned on. The present disclosure is not limited thereto. In Japan, the lighting state of traffic signal does not transition from yellow to green. However, in another region, yellow may be temporarily passed through before the lighting state transitions from red to green. That is, there may be a region where the lighting color of traffic signal transitions from yellow to green. In a region where the lighting color of traffic signal can transition from yellow to green, deceleration at the recognizing time of yellow light is unnecessary. In view of such circumstances, when only the yellow light element is turned on, the drive assist ECU 20 may perform the same system response as that in the case where the green light element is turned on. Specifically, in a case where the drive assist ECU 20 recognizes that only the yellow light is turned on, the drive assist ECU 20 may suspend deceleration for stopping and continue the preceding vehicle following control or the control for maintaining traveling at the set target speed.

The response policy in the case where only the yellow light is turned on may be properly changed corresponding to the region where the vehicle is used. For example, the drive assist ECU 20 may be configured to apply the traffic signal response policy corresponding to the traveling region based on a country code preset in a dealer shop, position coordinates specified by the GNSS, or the like.

### MODIFICATIONS

The drive assist ECU 20 may upload, as the traffic signal response report, a data set including the location information of activated light element within the traffic signal housing. According to this configuration, the traffic signal response policy generation unit G21 can define a passable pattern for each lane including not only a combination of lighting colors but also location information of lighting light element. As a result, it is possible to set a passable/stop pattern for each lane even for a traffic signal for which passing propriety of each lane cannot be distinguished only by a combination of the quantity of lighting colors.

The location of activated light element in the traffic signal may be expressed by XY coordinates with a predetermined location of housing, such as an upper left corner or an upper right corner of the housing as an origin. Further, as shown in FIG. 24, the housing may be divided into multiple areas corresponding to regions in which the light elements can be arranged, and the locations of activated light elements may be expressed by numeric numbers for the respective areas. FIG. 24 illustrates, as an example, a case where the housing is divided into six areas in two rows and three columns to express the activated light elements. The areas L11 to L13 correspond to an area group located in a relatively upper side (first row). The areas L21 to L23 correspond to an area group located in a relatively lower side (second row). For example, the area numbers can be assigned in order from the upper left to the lower right. The assigning rule of area number may be appropriately designed. Similarly, when the traffic signal 9 is of a vertical two-column type as shown in FIG. 25, the location of activated light element can be expressed by the row number and the column number.

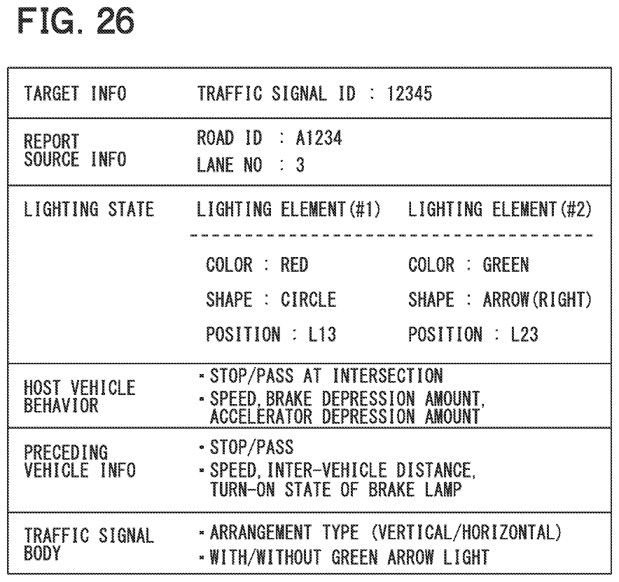

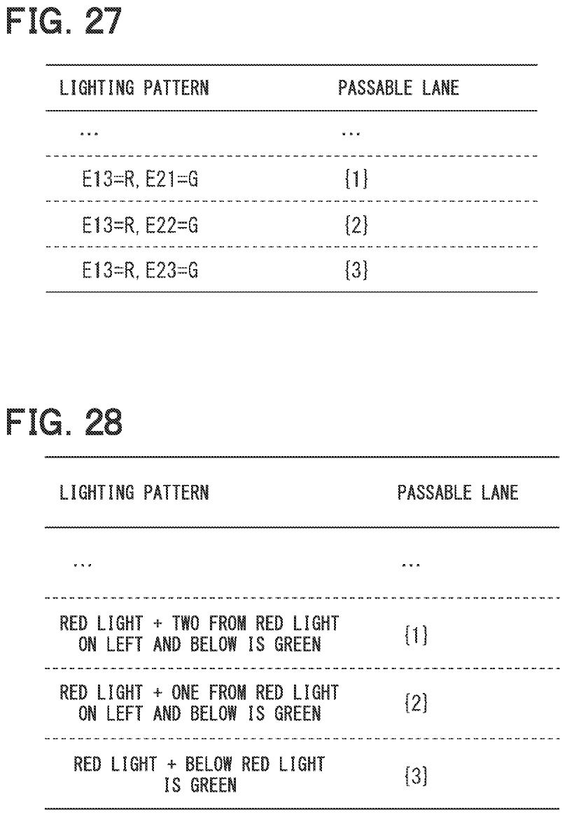

As illustrated in FIG. 26, the drive assist ECU 20 in the above configuration transmits the traffic signal response report including the location information of activated light element within the traffic signal housing in addition to the color of activated light element. Based on the traffic signal response report, the traffic signal response policy generation unit G21 may generate a data set indicating passable lanes for each lighting pattern, in other words, passable pattern for each lane by a combination of lighting location and a color thereof as illustrated in FIG. 27. A data set indicating a stop pattern for each lane can also be generated in the same manner. According to the configuration of generating and distributing the data set, for example, even with respect to the traffic signal 9/intersection having the lighting pattern as illustrated in FIG. 20, the drive assist ECU 20 can determine whether it is possible to pass through the intersection from a relatively long distance (at early time).

In the above description, the activated light element is expressed using an area number/location coordinates determined with reference to, for example, a corner portion of the housing. The expression format of activated light element is not limited thereto. The green arrow light element is often in turn-on state in parallel with the red light element. In view of such circumstances, the location information of activated green arrow light element may be expressed with reference to the red light element. For example, assuming the lighting pattern of FIG. 20, the passable pattern for each lane can be expressed as shown in FIG. 28. In an actual environment, there may be a scene in which the housing is difficult or impossible to be recognized, such as at night. In the configuration where the lighting location is defined based on the housing, when the housing is unclear such as at night, the lighting location cannot be specified, and the passing propriety cannot be determined. The configuration in which the location of green arrow light is expressed with reference to the red light is suitable in an environment where the housing itself is difficult to be detected, for example, at night. This is because there is a high possibility that the red light can be recognized even in a scene where the housing cannot be recognized because the housing is assimilated with the background.

In FIG. 28, for convenience of explanation, the lighting location with reference to the red light element is indicated by text. As another example, the lighting location may be expressed by a predetermined code (or number) indicating a relative location in terms of a program. FIG. 28 shows passable patterns in a case where the traffic signal 9, which has the lighting pattern shown in FIG. 20, is provided on the road, which has the lane configuration shown in FIG. 11.

### Note 1

The present disclosure also includes the following technical ideas.

### Technical Idea 1

A vehicle data generation server includes a traffic signal response policy generation unit, which generates, for each traffic signal, passable pattern data indicating a combination of passable lighting colors for each lane based on traffic signal response reports provided by multiple vehicles. The vehicle data generation server includes a transmission processing unit that transmits, to an external device, traffic signal response policy data, which is generated by the traffic signal response policy generation unit.

### Technical Idea 2

In the vehicle data generation server according to above technical idea 1, the traffic signal response policy generation unit generates passable pattern data for each traffic signal as a part of map data, which indicates a connection relationship of roads using multiple nodes and multiple links, and the transmission processing unit transmits the passable pattern data for each traffic signal to the external device in association with data of a node or a link where the corresponding traffic signal is installed.

### Technical Idea 3

In the vehicle data generation server according to above technical idea 1 or 2, the transmission processing unit transmits, to the vehicle, the passable pattern data for each traffic signal existing within a range corresponding to a position of the vehicle, in response to a request from the vehicle.

### Technical Idea 4

In the vehicle data generation server according to any one of above technical ideas (1) to (3), the transmission processing unit transmits, to the external device, data indicating whether the traffic signal is provided with an arrow light element that displays an arrow, as data related to traffic signal. For only the traffic signal provided with the arrow light element, the passable pattern data is attached to the data set and transmitted to the external device.

### Technical Idea 5

A vehicle control device includes: an acquiring unit that acquires information indicating a position of a host vehicle lane in a road width direction based on an input from a vehicle-mounted device; a lighting state acquiring unit that acquires data indicating a lighting state of a traffic signal corresponding to the host vehicle lane based on an input from a device identical to or different from the vehicle-mounted device; and a report processing unit that transmits, as a traffic signal response report, a data set indicating information on the host vehicle lane, a combination of lighting colors of traffic signal acquired by the lighting state acquiring unit, and behavior of the host vehicle, to a predetermined server as a traffic signal response report, in response to that the host vehicle stops before an intersection or passes through the intersection without stop.

### Note 2

The device, the system, and the method described in the present disclosure may be implemented by a dedicated computer that is configured by a processor programmed to execute one or more functions by executing a computer program. The device and method described in the present disclosure may also be implemented using dedicated hardware logic circuitry. The device and method described in the present disclosure may be implemented by one or more dedicated computers configured by a combination of a processor that executes a computer program and one or more hardware logic circuits. For example, partial or entire functions of the drive assist ECU 20/map generation server 3 may be implemented by hardware logic circuitry. A configuration in which certain function is implemented by hardware logic circuitry includes a configuration in which the function is implemented using one or more ICs or the like. As the processor (arithmetic core), a CPU, an MPU, a GPU, a DFP (Data Flow Processor), or the like can be adopted. Partial or entire of the functions of the drive assist ECU 20/the map generation server 3 may be implemented by combining multiple types of arithmetic processing devices. Partial or entire of the functions of the drive assist ECU 20/map generation server 3 may be implemented using a system-on-chip (SoC), an FPGA, an ASIC, or the like. FPGA is an abbreviation for Field-Programmable Gate Array. ASIC is an abbreviation for Application Specific Integrated Circuit.

The computer program described above may be stored in a computer-readable non-transitory tangible storage medium as instructions to be executed by a computer. As a storage medium for storing the computer program, a hard disk drive (HDD), a solid state drive (SSD), a flash memory, or the like can be adopted. Forms such as a program for causing a computer to function as the drive assist ECU 20/the map generation server 3 and a non-transitory tangible storage medium such as a semiconductor memory in which the program is recorded are also included in the scope of the present disclosure.

What is claimed is:

1. A vehicle data generation server generating vehicle control data with respect to a traffic signal, the vehicle data generation server comprising:
a report acquiring unit acquiring, from each of multiple vehicles, a data set as a traffic signal response report, the data set indicating information on (i) a travel lane of the corresponding vehicle, (ii) a combination of activated colors of the traffic signal observed by the corresponding vehicle, and (iii) a behavior of the corresponding vehicle with respect to the combination of activated colors of the traffic signal;
a traffic signal response policy generation unit generating, as traffic signal response policy data for each traffic signal, passable pattern data indicating, for each lane, a combination of activated colors under which passing is possible, based on the traffic signal response reports acquired by the report acquiring unit; and
a transmission processing unit transmitting the traffic signal response policy data generated by the traffic signal response policy generation unit to an external device,
wherein p1 the passable pattern data is a data set indicating, for the combination of activated colors, one or more passable lane numbers, and
the passable pattern data does not include data indicating a shape of each activated light element included in the traffic signal.

2. The vehicle data generation server according to claim 1, wherein
the traffic signal response policy generation unit generates the passable pattern data as the traffic signal response policy data, and
the passable pattern data is a data set indicating, for a combination of respective quantities of activated colors, one or more passable lanes.

3. The vehicle data generation server according to claim 1, wherein
the passable pattern data indicates a passable lane when a red light element, which is a light device configured to turn on in red, and a green arrow light element, which is a light device configured to turn on in green arrow, are activated, and
the passable pattern data is a data set indicating the passable lane using a relative position of the activated green arrow light element with respect to the activated red light element.

4. The vehicle data generation server according to claim 1, wherein
the traffic signal response report includes information on a location and a color of each activated light element included in the traffic signal, and
the passable pattern data is a data set indicating a passable lane using a combination of the location and the color of each activated light element included in the traffic signal.

5. The vehicle data generation server according to claim 1, wherein
the traffic signal response policy generation unit:
generates the passable pattern data for the traffic signal that includes an arrow light element, the arrow light element being a light device configured to turn on in arrow shape; and
does not generate the passable pattern data for a standard traffic signal that does not include the arrow light element.

6. The vehicle data generation server according to claim 1, wherein
the traffic signal response policy generation unit generates stop pattern data instead of the passable pattern data, and
the stop pattern data indicates, for each lane, a combination of activated colors under which stop is required.

7. A vehicle control device configured to perform a preceding vehicle following control by controlling a host vehicle to follow a preceding vehicle with a predetermined distance being maintained from the preceding vehicle, the vehicle control device comprising:
a host vehicle lane recognition unit recognizing, based on an input from a vehicle-mounted device, a lane number of a host vehicle lane when counted from a left or right edge of a road, the host vehicle lane being a lane in which a host vehicle is traveling;
a lighting state acquiring unit acquiring data indicating a lighting state of a traffic signal corresponding to the host vehicle lane;
a response policy data receiving unit receiving, from a predetermined external device, traffic signal response policy data indicating a combination of passable lighting colors set for each lane or a combination of lighting colors under which passing is prohibited for each lane, as data related to the traffic signal located along the road which the host vehicle is scheduled to travel;
a passing propriety determination unit determining whether the lighting state of the traffic signal corresponds to a passable lighting state in which passing is defined to be possible, based on (i) the traffic signal response policy data received by the response policy data receiving unit, (ii) the lane number of the host vehicle lane, and (iii) the lighting state of the traffic signal acquired by the lighting state acquiring unit; and
a response unit performing a vehicle control in response to a determination result of the passing propriety determination unit,
wherein
the response unit continues the preceding vehicle following control when the passing propriety determination unit determines that passing is possible and the host vehicle is scheduled to travel straight at an intersection where the traffic signal is located, and
the response unit interrupts the preceding vehicle following control when the passing propriety determination unit determines that passing is prohibited at the intersection where the traffic signal is located.

8. The vehicle control device according to claim 7, wherein,
in response to the passing propriety determination unit determining that passing is prohibited, the response unit starts an automatic deceleration control or executes a notification process for prompting a driver to execute a deceleration operation.

9. The vehicle control device according to claim 7, wherein,
even though the passing propriety determination unit determines that passing is possible, the response unit starts a deceleration control when a right turn or a left turn is scheduled at the intersection where the traffic signal is located.

10. The vehicle control device according to claim 7, wherein
the vehicle control device automatically adjusts a travel speed according to a traveling environment,
the passing propriety determination unit outputs a determination failure signal, which indicates that the passing propriety determination unit is impossible to determine that the lighting state of the traffic signal corresponds to the passable lighting state, in a case where (i) the lane number of host vehicle lane is unknown, (ii) the traffic signal response policy data is not acquired, (iii) the lighting state of the traffic signal is not acquired, or (iv) the acquired lighting state of the traffic signal is not defined in the traffic signal response policy data, and
the response unit interrupts a control of automatically adjusting the travel speed and performs a control interruption notification process by outputting an interruption notification of the control to a driver in response to the passing propriety determination unit outputting the determination failure signal.

11. The vehicle control device according to claim 10, wherein,
when a remaining distance or a remaining period to arrival at the intersection where the traffic signal is located is equal to or more than a threshold value, the response unit continues the control of automatically adjusting the travel speed even though the passing propriety determination unit outputs the determination failure signal, and
when the remaining distance or the remaining period to arrival at the intersection where the traffic signal is located is less than the threshold value and the passing propriety determination unit outputs the determination failure signal, the response unit interrupts the control of automatically adjusting the travel speed and execute the control interruption notification process.

12. The vehicle control device according to claim 7, wherein,
when a remaining distance to the intersection where the traffic signal is located is less than a predetermined value, a display displays an image indicating a determination result determined by the passing propriety determination unit.

13. The vehicle control device according to claim 7, further comprising
a report processing unit transmitting, to a predetermined server, a data set indicating (i) the lane number of the host vehicle lane recognized by the host vehicle lane recognition unit, (ii) a combination of activated light elements of the traffic signal acquired by the lighting state acquiring unit, and (iii) a behavior of the host vehicle, when the host vehicle stops at the intersection where the traffic signal is located or passes through the intersection without stop,
wherein the data set is transmitted to the predetermined server as a traffic signal response report.

14. A vehicle data generation server generating vehicle control data with respect to a traffic signal, the vehicle data generation server comprising:
a computer-readable non-transitory storage medium; and
a processor, by executing program code stored in the computer-readable non-transitory storage, configured to:
acquire, from each of multiple vehicles, a data set as a traffic signal response report, the data set indicating information on (i) a travel lane of the corresponding vehicle, (ii) a combination of activated colors of the traffic signal observed by the corresponding vehicle, and (iii) a behavior of the corresponding vehicle with respect to the combination of activated colors of the traffic signal;
generate, as traffic signal response policy data for each traffic signal, passable pattern data indicating, for each lane, a combination of activated colors under which passing is possible, based on the traffic signal response reports acquired from the multiple vehicles; and
transmit the traffic signal response policy data that is generated to an external device,
wherein
the passable pattern data is a data set indicating, for the combination of activated colors, one or more passable lane numbers, and
the passable pattern data does not include data indicating a shape of each activated light element included in the traffic signal.
